(19) United States
(12) Patent Application Publication
(10) Pub. No.: US 2014/0120339 A1
(43) Pub. Date: May 1, 2014

(54) POROUS CARBON MONOLITHS TEMPLATED BY PICKERING EMULSIONS

(71) Applicant: CABOT CORPORATION, Boston, MA (US)

(72) Inventors: Ani T. Nikova, Winchester, MA (US); Arijit Bose, Lexington, MA (US); Ravi Sharma, Acton, MA (US)

(73) Assignee: CABOT CORPORATION, Boston, MA (US)

(21) Appl. No.: 13/804,306

(22) Filed: Mar. 14, 2013

Related U.S. Application Data
(60) Provisional application No. 61/720,609, filed on Oct. 31, 2012.

(51) Int. Cl. B01J 20/20; B01J 20/30; B01J 32/00

(52) U.S. Cl. CPC B01J 20/20; B01J 32/00; B01J 20/3078
USPC 428/312.2; 502/416; 502/401; 502/413; 502/415; 502/80; 252/183.13; 502/439; 428/221

(57) ABSTRACT

Porous carbon monoliths are prepared using emulsions stabilized by carbonaceous particles or aggregates. An illustrative porous carbon monolith comprises carbon black, including any graphitized carbon black particles, carbonized binder and porosity. The porosity includes first pores having a pore size within the range of from about 0.5 μm to about 100 μm and second pores having a pore size within the range of from about 1 nm to about 100 nm. The pore size distribution of the first pores does not overlap with a pore size distribution of the second pores.

### CROSS REFERENCE TO RELATED APPLICATIONS

This patent application claims the benefit of U.S. Provisional Patent Application No. 61/720,609, filed Oct. 31, 2012, the entire contents of which are incorporated herein by reference.

### BACKGROUND OF THE INVENTION

Lithium-ion batteries, catalysis, chromatography and other applications have generated considerable interest in the development of materials having desired properties. Carbon-containing foams, for example, have been prepared using graphite, graphene, and both multi-walled and single-walled carbon nanotubes.

One approach for producing composite polymeric foams that contain multi-walled carbon nanotubes uses blowing agents and surfactants, as described by M. Hermant et al. in the article Conductive Pickering-Poly (High Internal Phase Emulsion) Composite Foams Prepared With Low Loadings of Single-Walled Carbon Nanotubes, published in Chemical Communications 19:2738-2740, 2009. In a different approach (Hermant et al.) composite polymeric foams with low loadings of single-walled carbon nanotubes (SWCNT) have been prepared using high internal phase emulsions or HIPE (typically defined as emulsions in which the internal droplet phase occupies at least 74 volume % in order to coincide with the maximum packing efficiency of perfect spheres). Porous polymer foams also have been produced via medium internal phase emulsions or MIPE (where the dispersed phase is about 60 volume %) stabilized with surface-oxidized carbon nanotubes, as described by A. Menner et al. in the article, Particle-Stabilized Surfactant-Free Medium Internal Phase Emulsions as Templates for Porous Nanocomposite Materials: poly-Pickering-Foams, published in Langmuir 23(5):2398-2403, 2007.

Another known technique for obtaining polymer foams uses monomer as a continuous phase in a particle stabilized emulsion, followed by polymerization of the monomer, as disclosed in International Publication No. WO 2009/013500 A1, published on Jan. 29, 2009 with the title Particle Stabilized High Internal Phase Emulsions. Typically, the particles are hydrophobized metal oxide particles such as titania, which can be used in combination with carbon particles. When used solely in an attempt to stabilize a HIPE, carbon particles were found to generate an oil in water (O/W) emulsion.

In the article, Synthesis Of Carbon Black/Polystyrene Conductive Nanocomposite Pickering Emulsion Effect Characterized By TEM, published in Micron 42(3):263-270, 2011, E. Zaragoza-Contreras et al. describe a polystyrene carbon black porous composite produced by adsorbing the carbon black onto the surface of the polystyrene, followed by dispersion into an aqueous phase containing surfactants, followed by polymerization.

Carbon foams also have been prepared. In one approach (Japanese Patent Publication No. 60036316), graphite, phenolic resin, curing agent, blowing agent (trichloromonofluoromethane) and surface active agent are blended into a uniform dispersion, cast, heated and cured, then heated at ≧1000° C. in a nonoxidizing atmosphere.

Also known (International Publication No. WO 2007/137795 A1, published on Dec. 6, 2007 with the title Porous Electrically Conductive Carbon Material And Uses Thereof) is to combine graphene and polymer, followed by pyrolysis to produce carbon foam having a bimodal distribution. In a different approach, described in International Publication No. WO 2010/102250 A1, published on Sep. 10, 2010 with the title Method For Making Cohesive Assemblies Of Carbon, carbon foams are prepared by dispersing carbon nanotubes, graphite, expanded graphite or amorphous carbon in liquid halogen, followed by evaporating the halogen. As disclosed in Synthesis Of Hierarchically Porous Carbon Monoliths With Highly Ordered Microstructure And Their Application In Rechargeable Lithium Batteries With High-Rate Capability, by Y. Hu et al., published in Advanced Functional Materials 17(12):1873-1878, 2007, mesomacroporous silica has been used as a template and infiltrated with carbon pitch. The pitch is carbonized and the silica is removed to form a carbon foam.

Nanoporous monoliths composed of carbonaceous material can use “linkers” to form aggregates, as described, for example, in U.S. Patent Application Publication No. 2004/0028901 to Rumpf, which is incorporated herein by reference in its entirety. When a carbonaceous material, for instance carbon black, is dispersed in a liquid medium, it is possible to form aggregates in the absence of a linker. This is done by choosing a liquid, such as water, that will be repelled by the carbon black because of its hydrophobic surfaces, causing aggregates of carbon black to be attracted to each other and form a continuous network in the water. Removable substances can be used to generate voids and channels.

Monolithic and metal-doped monolithic carbon disks have been prepared using prepolymer organic precursors in the powder form composed of either or both polyimide and polybenzimidazole, as shown in U.S. Patent Application No. 2006/0033226 A1 to Wang, published on Feb. 16, 2006. Carbon can be added to the prepolymer organic precursors. The powders are compressed into disks, then pyrolyzed to form the desired porous carbon disk.

The techniques discussed above present some disadvantages. Carbon nanotubes, for example, often are generated in the laboratory or on a small scale, requiring complex procedures and equipment and raising significant cost considerations. In addition, existing approaches often rely on hazardous materials such as liquid halogens, blowing agents and others. In some cases, the pore size produced is very specific to each particular foaming method.

Moreover, the solids loading in the particle-stabilized systems described above are low. Higher particle loadings increase the viscosity of the emulsion, making it difficult to achieve uniform mixing. However, this limits the flexibility of synthesis techniques and the ability to use the solid particle to control pore size distribution. In addition, low solids loadings can limit the mechanical stability of the resulting dry foam.

In addition, the pore size distributions in many of the systems described above are unimodal. In those systems where the pore size distribution is considered bimodal, the pore size distributions still overlap. Such systems may not be able to accommodate different materials having dramatically different sizes.

### SUMMARY OF THE INVENTION

Thus a need continues to exist for porous carbon monoliths and methods for producing them. A need also exists for designing porous monoliths having a desired porous structure.

We have successfully used higher concentrations of carbonaceous aggregates in emulsions utilized to generate porous monoliths. This has been accomplished without burning off the carbon component of the carbonaceous aggregates discussed below. Instead, a small amount of a carbon-containing resin is used to provide a link between individual particles. The resin is then carbonized to create a porous carbon monolith. These monoliths demonstrate desirable mechanical strengths and pore size distributions.

Furthermore, we have produced porous monoliths having bimodal pore size distributions in which there is little to no overlap between the sizes of the two types of porosity. Such monoliths may provide advantages in performing chromatographic separations, especially size exclusion chromatography, and in preparing fuel cells, batteries, and other electrochemical devices, in which it is desirable to conduct items having dramatically different sizes (e.g., liquids and charged species such as electrons and ions).

In one implementation, a method for producing a porous carbon monolith comprises forming a particle stabilized emulsion including immiscible liquids, carbon black particles and a binder; removing liquids present in the particle stabilized emulsion; and decomposing the binder to produce the porous carbon monolith.

In a further implementation, a particle stabilized oil-water emulsion comprises a binder and carbon black particles in an amount of at least 5% by weight of the water phase of the emulsion, wherein partial hydrophobicity and partial hydrophilicity are displayed in the same carbon black particle.

In another implementation, a method for producing a porous carbon monolith comprises forming a particle stabilized emulsion including immiscible liquids, carbonaceous particles or aggregates and a binder; removing liquids present in the particle stabilized emulsion; and decomposing the binder to produce the porous carbon monolith. The binder may be selected form the group consisting of phenolic resin, starch and sucrose or may be an organic compound having a high carbon content. The binder may be decomposed by heating in the absence of oxygen and/or by heating at a temperature within the range of from about 800° C. to about 1500° C. The binder may be decomposed by treatment with a chemical agent that removes oxygen and hydrogen from the binder molecule. The decomposition of the binder may generate elemental carbon.

At least a portion of the carbonaceous aggregates may be present in a continuous phase of the particle stabilized emulsion. The porous carbon monolith may be further processed to obtain a particulate material. The method may further include attaching at least one organic group to a surface of the porous carbon monolith. The porous carbon monolith, optionally granulated, may be surface modified. The carbonaceous aggregates may comprise carbon black. The carbon black particles may be provided in an amount within the range of from about 5 to about 55 weight percent based on an aqueous phase of the emulsion. The ratio by weight of binder to carbon black may be within the range of from about 0.2 to about 2. The immiscible liquids may include water and an organic compound immiscible with water and the ratio of carbon black to the organic compound may be within the range of from about 0.16 to about 0.96 by weight.

The carbonaceous aggregate may be at least partially hydrophilic. The carbonaceous aggregate may be at least partially hydrophobic and at least partially hydrophilic. The partial hydrophobicity and partial hydrophilicity may be displayed in the same particle. The carbonaceous aggregate may have a BET within the range of from about 10 m²/g to about 1500 m²/g. The carbonaceous aggregate may have a particle size within the range of from about 50 nm and about 400 nm.

The carbonaceous aggregate may comprise a surface-modified carbon black or an oxidized carbon black. The surface modified carbon black or the oxidized carbon black may be provided in combination with other particles. The particle-stabilized emulsion may further contain particles selected from the group consisting of unmodified fumed silica, colloidal silica, hydrophobically modified fumed silica, hydrophobically modified colloidal silica, hydrophobically modified precipitated silica, clay, alumina, activated carbon, ceria, palladium, unmodified carbon black particles and any combination thereof.

The carbonaceous aggregate may be provided as carbon black particles in an aqueous dispersion. The dispersion may be a dispersion of sulfanilic acid treated high surface area carbon black or a dispersion of para-amino-benzoic acid treated high surface area carbon black. The immiscible liquids may include water and an organic compound immiscible with water. The liquid present in the particle stabilized emulsion may be removed by drying. The drying may be conducted at a temperature within the range of from about 25° C. to about 120° C.

In another implementation, a porous carbon monolith is prepared by any of the methods described above.

In another implementation, a porous carbon monolith comprises carbon and porosity, wherein the carbon includes carbonaceous aggregates and carbonized binder and said porosity comprises first pores having a pore size within the range of from about 0.5 μm to about 100 μm and second pores having a pore size within the range of from about 1 nm to about 100 nm, wherein a pore size distribution of the first pores does not substantially overlap with a pore size distribution of the second pores.

In another implementation, a porous carbon monolith consists of carbon, optional secondary particles and porosity, wherein the carbon includes carbonaceous aggregates and carbonized binder and said porosity comprises first pores having a pore size within the range of from about 0.5 μm to about 100 μm and second pores having a pore size within the range of from about 1 nm to about 100 nm, wherein a pore size distribution of the first pores does not substantially overlap with a pore size distribution of the second pores.

In another implementation, a porous carbon monolith consists of carbon black, including any graphitized carbon black particles, carbonized binder, optional secondary materials and porosity, said porosity comprising first pores having a pore size within the range of from about 0.5 μm to about 100 μm and second pores having a pore size within the range of from about 1 nm to about 100 nm, wherein a pore size distribution of the first pores does not substantially overlap with a pore size distribution of the second pores.

For any of these porous carbon monoliths described above, fewer than 10% of the pores might have a diameter from about 110 nm to about 490 nm. The ratio of the number of pores having a size within the first range (of from about 0.5 μm to about 100 μm) to the number of pores having a size within the second range (of from about 1 nm to about 100 nm) may be from about 90:10 to about 10:90. The amount of first pores present may be within the range of from about 10 to about 35 volume %. The total porosity present in the porous carbon monolith may be within the range of from about 35 to about 45 volume percent. At least about 30 volume % of the total porosity may be macroporosity. The carbonaceous aggregates may comprise carbon black and optional graphitized carbon black. The porous carbon monolith may have a density within the range of from about 0.25 to about 0.3 g/cm³. Such a porous carbon monolith may exhibit sufficient mechanical strength to not be friable. Any of the above monoliths may have at least one organic group attached to its surface.

In another implementation, a chromatographic medium includes any implementation of the porous carbon monolith described above. Alternatively or in addition, a battery device includes any implementation of the porous carbon monolith described above.

In another implementation, a particle stabilized oil-water emulsion comprises a binder and carbon black particles in an amount of at least 5% by weight of the water phase of the emulsion, wherein partial hydrophobicity and partial hydrophilicity are displayed in the same carbon black particle.

In yet another implementation, a porous carbon monolith comprises carbon black, including any graphitized carbon black particles, carbonized binder and porosity, the porosity including first pores having a pore size within the range of from about 0.5 μm to about 100 μm and second pores having a pore size within the range of from about 1 nm to about 100 nm, wherein a pore size distribution of the first pores does not overlap or does not substantially overlap with a pore size distribution of the second pores. In one implementation, fewer than 10% of the pores have a diameter from about 110 nm to about 490 nm, for example, fewer than about 8% of the pores, fewer than about 6%, fewer than about 4%, or fewer than about 2% of the pores have a diameter from about 110 nm to about 490 nm.

In a specific embodiment, the ratio of the number of pores having a size within the first range (from about 0.5 μm to about 100 μm) to the number of pores having a size within the second range (about 1 nm to about 100 nm) is from about 90:10 to about 10:90, for example, about 90:10 to about 80:20, about 80:20 to about 70:30, about 70:30 to about 60:40, about 60:40 to about 50:50, about 50:50 to about 40:60, about 40:60 to about 30:70, about 30:70 to about 20:80, or about 20:80 to about 10:90.

In a further implementation, a porous carbon monolith comprises carbon and porosity, wherein the carbon includes carbonaceous aggregates and carbonized binder, and wherein the porosity includes first pores having a pore size within the range of from about 0.5 μm to about 100 μm and second pores having a pore size within the range of from about 1 nm to about 100 nm, wherein a pore size distribution of the first pores does not overlap or does not substantially overlap with a pore size distribution of the second pores. In one implementation, fewer than 10% of the pores have a diameter from about 110 nm to about 490 nm, for example, fewer than about 8% of the pores, fewer than about 6%, fewer than about 4%, or fewer than about 2% of the pores have a diameter from about 110 nm to about 490 nm.

In one implementation, the ratio of the number of pores having a size within the first range (from about 0.5 μm to about 100 μm) to the number of pores having a size within the second range (about 1 nm to about 100 nm) is from about 90:10 to about 10:90, for example, about 90:10 to about 80:20, about 80:20 to about 70:30, about 70:30 to about 60:40, about 60:40 to about 50:50, about 50:50 to about 40:60, about 40:60 to about 30:70, about 30:70 to about 20:80, or about 20:80 to about 10:90.

In one example, a porous carbon monolith comprises, consists essentially of, or consists of carbon black, any graphitized carbon black particles, carbonized binder, optional secondary materials and porosity, the porosity including first pores having a pore size within the range of from about 0.5 μm to about 100 μm and second pores having a pore size within the range of from about 1 nm to about 100 nm, wherein a pore size distribution of the first pores does not overlap or does not overlap or substantially overlap with a pore size distribution of the second pores. In one implementation, fewer than 10% of the pores have a diameter from about 110 nm to about 490 nm, for example, fewer than about 8% of the pores, fewer than about 6%, fewer than about 4%, or fewer than about 2% of the pores have a diameter from about 110 nm to about 490 nm.

In a specific embodiment, the ratio of the number of pores having a size within the first range (from about 0.5 μm to about 100 μm) to the number of pores having a size within the second range (about 1 nm to about 100 nm) is from about 90:10 to about 10:90, for example, about 90:10 to about 80:20, about 80:20 to about 70:30, about 70:30 to about 60:40, about 60:40 to about 50:50, about 50:50 to about 40:60, about 40:60 to about 30:70, about 30:70 to about 20:80, or about 20:80 to about 10:90.

In another example, a porous carbon monolith comprises, consists essentially of, or consists of carbon, optional secondary materials and porosity, wherein the carbon includes carbonaceous aggregates and carbonized binder, and the porosity comprises first pores having a pore size within the range of from about 0.5 μm to about 100 μm and second pores having a pore size within the range of from about 1 nm to about 100 nm, wherein a pore size distribution of the first pores does not overlap or does not substantially overlap with a pore size distribution of the second pores. In one implementation, fewer than 10% of the pores have a diameter from about 110 nm to about 490 nm, for example, fewer than about 8% of the pores, fewer than about 6%, fewer than about 4%, or fewer than about 2% of the pores have a diameter from about 110 nm to about 490 nm.

In one embodiment, the ratio of the number of pores having a size within the first range (from about 0.5 μm to about 100 μm) to the number of pores having a size within the second range (about 1 nm to about 100 nm) is from about 90:10 to about 10:90, for example, about 90:10 to about 80:20, about 80:20 to about 70:30, about 70:30 to about 60:40, about 60:40 to about 50:50, about 50:50 to about 40:60, about 40:60 to about 30:70, about 30:70 to about 20:80, or about 20:80 to about 10:90.

The invention presents many advantages. In many of its aspects, the invention provides a versatile method for producing carbon monoliths, allowing for a deliberate design of the porous structure. Pore size and, possibly, pore connectivity can be tailored to a targeted application. For instance, techniques such as the emulsion templating described here can generate controllable porosity, producing a hierarchical structure, with macroporous (e.g., 1 micron (μm) to 100 μm), derived from the size of emulsion droplets, and mesoporous (e.g., a few nanometers (nm) to 100 nm) length scale derived from the packing of carbon particulates within the carbon phase of the porous monolith. Specific implementations of the invention allow flexibility in the level of mesoporosity achieved in the porous carbon monolith. High surface area and/or high structure carbon blacks, for example, may be used to increase this type of porosity.

Generally, approaches described herein do not appear to compromise the electrical conductivity of carbonaceous aggregates such as carbon black, and the materials obtained typically are electrically conductive. If desired, use of non-porous carbonaceous aggregates such as non-porous carbon black can preserve or substantially preserve surface area, a property important in some applications, such as, for example, in the manufacture of battery devices. Mechanical toughness can be controlled and tuned, for instance, by the amount of added binder. Binder type and amounts also can be used to balance mechanical properties and porosity in the resulting monolith.

In most cases, practicing the invention utilizes readily available and inexpensive starting materials as well as relatively simple equipment and procedures.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is an optical image of a carbon black stabilized Pickering emulsion according to embodiments described herein.

FIG. 2A is a thin section TEM image showing macropores of a porous carbon monolith according to embodiments described herein.

FIG. 2B is a thin section TEM image showing mesopores of a porous carbon monolith according to embodiments described herein.

FIG. 3 is a SEM image showing macropores templated by emulsion drops according to embodiments described herein.

FIGS. 4A and 4B are SEM images of a porous carbon monolith prepared using carbon black and a sucrose binder.

FIGS. 5A and 5B are SEM images of a porous carbon monolith according to embodiments described herein.

### DETAILED DESCRIPTION OF THE PREFERRED EMBODIMENTS

The invention generally relates to porous carbon materials and methods for producing them. Embodiments of the invention utilize templating emulsions that contain carbonaceous aggregates.

Generally, emulsions are mixtures of two or more immiscible liquids, wherein droplets of one liquid are dispersed within the other. When two immiscible liquids are combined, without additional components or vigorous mixing, they will segregate into separate phases. If the two liquids are vigorously mixed, they will briefly form an unstable emulsion before re-segregating into separate phases.

Common mechanisms for emulsion instability include flocculation, creaming, and coalescence. During flocculation, for example, droplets are in contact and form loosely bound aggregates. Emulsions that undergo creaming are characterized by the migration of one of the substances to the top (or the bottom, depending on the relative densities of the two phases) of the emulsion under the influence of buoyancy or centripetal force when a centrifuge is used. During coalescence small droplets combine to form progressively larger ones.

Emulsifiers are agents used to stabilize emulsions. Typically, emulsifiers that stabilize oil-in-water emulsions have hydrophobic groups that interact with oil and hydrophilic groups that interact with water. These emulsifiers reduce the oil-water interfacial tension, lowering the energy penalty associated with forming new oil-water interfaces. They also provide additional surface elasticity and viscosity to suppress thinning of the continuous phase when droplets approach each other, thus preventing drop-drop contact required for coalescence.

Particle-stabilized emulsions, also known as Pickering emulsions, generally are more resistant to coalescence than those stabilized by surfactants. Pickering emulsions are characterized by solid particles such as colloidal silica that adsorb onto the interface between the two phases. Generally the phase that preferentially wets the particle will be the continuous phase in the emulsion system.

The energy barrier for removal of particles from the interface is so high that particles adsorb essentially irreversibly at the interface. When enough particles adsorb at an interface, they become jammed and particle motion along the interface, e.g., oil water interface, is highly retarded. Since drop-drop coalescence would require particles to be displaced from the interfaces into one of the bulk phases, these emulsions remain kinetically stable. As a result, particle stabilized emulsions can have significantly longer lifetimes than those stabilized by surfactants. Other stabilization mechanisms have been proposed to explain evidence that particles can stabilize an emulsion even when they are not completely covering the droplet.

In many cases, the emulsion will form spherical droplets (also referred to as drops). The particle stabilized emulsions described herein may be formed to have a droplet average diameter within the range of from about 0.5 micron to about 300 microns, for example within the range of from about 10 microns to about 250, 200, 180 or 160 microns, e.g., within the range of from about 20 microns to about 150 microns. In some cases the droplet average diameter is within the range of from about 30 or 40 microns to about 120 microns. In other cases, the droplet average diameter is within the range of from about 50 microns to about 75, 80, 90 or 100 microns. In one example, the droplets have a diameter within a range of from about 1 to about 100 microns.

Suitable emulsion systems include two immiscible liquids. For illustrative purposes, some of the emulsions described herein are referred to as oil-water emulsions, where “oil” denotes any suitable water-immiscible compound. The oil can be, for example, any organic compound or other nonpolar substance which is not completely soluble in water, or in an aqueous phase, at all proportions. Suitable organic compounds include, but are not limited to hydrocarbons such as aromatics, for example benzene, toluene and xylene, aliphatics, for example alkanes such as pentanes, hexanes, e.g., n-hexane and cyclohexane, heptanes, octanes, e.g., n-octane and isooctanes, nonanes, decanes, undecanes, and dodecanes, alkenes, esters, ethers, polyethers, ketones, long-chain alcohols, e.g. n-octanol, organosilicon compounds such as silicones, e.g. linear or cyclic polydialkylsiloxanes, polydimethylsiloxanes having 0-10% by weight of methylsiloxy and/or trimethylsiloxy units in addition to 90-100% by weight of dimethylsiloxy units, or any mixtures thereof. The “water” phase can be an aqueous salt solution. Since high salt concentrations may cause emulsion destabilization, typical salt amounts are present at levels that will not affect the emulsion stability.

Oil-water emulsions can be oil in water (O/W) where oil droplets are dispersed in water, which forms the continuous phase, or water-in-oil (W/O) where it is the oil that forms the continuous phase around water droplets.

Emulsions also can form in the absence of an aqueous phase. Exemplary systems include non-aqueous immiscible phases, such as, for example, non-polar and highly polar non-aqueous compounds, e.g., amides such as formamide or dimethylformamide; glycols such as ethylene glycols; polyalcohols such as glycerol; lower alcohols such as methanol; alkylated sulfoxides such as dimethyl sulfoxide; acetonitrile; or their solutions.

Particles utilized to stabilize the emulsions described herein are solid particles that consist, consist essentially of, or comprise carbon. In specific embodiments of the invention, the particles employed are referred to as “carbonaceous aggregates” and include carbon black particles or other carbon-containing aggregates as further described below. The term “aggregates” indicates that the particles are comprised of primary particles fused to one another.

Many carbon blacks are produced in a furnace-type reactor by pyrolyzing a hydrocarbon feedstock with hot combustion gases to produce combustion products containing particulate carbon black. Other carbon blacks include thermal blacks, channel blacks, gas blacks, lamp blacks and acetylene blacks. Carbon black exists in the form of aggregates, which, in turn, are formed of carbon black primary particles. In most cases, primary particles do not exist independently of the carbon black aggregate. Properties of a given carbon black typically depend upon the conditions of manufacture and may be altered, e.g., by changes in temperature, pressure, feedstock, residence time, quench temperature, throughput, and other parameters.

Carbon blacks and other carbonaceous aggregates can be characterized on the basis of analytical properties, including, but not limited to particle size and specific surface area; aggregate size, shape, and distribution; and chemical and physical properties of the surface. These properties are analytically determined by tests known to the art. For example, nitrogen adsorption surface area (measured by ASTM test procedure D3037—Method A) and cetyl-trimethyl ammonium bromide adsorption value (CTAB) (measured by ASTM test procedure D3765 [09.01]), are measures of specific surface area. Statistical thickness surface area (STSA), another measure of surface area, is determined by nitrogen adsorption following ASTM test procedure D-5816. The Iodine number can be measured using ASTM procedure D-1510. Aggregate “structure” describes the size and complexity of aggregates, for example, aggregates of carbon black formed by the fusion of primary carbon black particles to one another. As used here, the structure of the carbonaceous aggregates can be measured as the dibutyl phthalate (DBP) adsorption (DBPA or DBP value) for the uncrushed powder, expressed as milliliters of DBP per 100 grams carbon black, according to the procedure set forth in ASTM D-2414.

The carbonaceous aggregates, e.g., carbon black, utilized in aspects of the invention are characterized by their nitrogen adsorption, measured by Brunauer/Emmett/Teller (BET) technique according to the procedure of ASTM D6556. Suitable carbon blacks and other carbonaceous aggregates can have a BET surface area between 10 m²/g and 1500 m²/g, for instance between 20 m²/g and 250 m²/g, e.g., between 40 m²/g and 175 m²/g. In some cases, the BET surface area in within the range of from about 25 m²/g to about 50 m²/g; from about 50 m²/g to about 75 m²/g; from about 75 m²/g to about 100 m²/g; from about 100 m²/g to about 125 m²/g; from about 125 m²/g to about 150 m²/g; from about 150 m²/g to about 175 m²/g; from about 175 m²/g to about 200 m²/g; from about 200 m²/g to about 225 m²/g; from about 225 m²/g to about 250 m²/g; from about 250 m²/g to about 275; m²/g from about 275 m²/g to about 300 m²/g; from about 300 m²/g to about 350 m²/g; from about 350 m²/g to about 375 m²/g; from about 375 m²/g to about 400 m²/g; from about 400 m²/g to about 500 m²/g; from about 500 m²/g to about 600 m²/g; from about 600 m²/g to about 700 m²/g; from about 700 to about 800 m²/g; from about 800 m²/g to about 900 m²/g; from about 900 to about 1000 m²/g; from about 1000 m²/g to about 1100 m²/g; from about 1100 m²/g to about 1200 m²/g; from about 1200 m²/g to about 1300 m²/g; from about 1300 m²/g to about 1400 m²/g; from about 1400 m²/g to about 1500 m²/g. The DBPA may be between 29 mL/100 g and 300 mL/100 g, for instance between 30 mL/100 g and 250 mL/100 g. In some implementations the DBPA is within the range of from about 30 mL/100 g to about 50 mL/100 g; from about 50 mL/100 g to about 75 mL/100 g; from about 75 mL/100 g to about 100 mL/100 g; from about 100 mL/100 g to about 125 mL/100 g; from about 125 mL/100 g to about 150 mL/100 g; from about 150 mL/100 g to about 175 mL/100 g; from about 175 mL/100 g to about 200 mL/100 g; from about 200 mL/100 g to about 225 mL/100 g; from about 225 mL/100 g to about 250 mL/100 g; from about 250 mL/100 g to about 275 mL/100 g; from about 275 mL/100 g to about 300 mL/100 g, e.g. In some cases the DBPA is between 50 mL/100 g and 180 mL/100 g or between 50 mL/100 g and 150 mL/100 g, such as between 50 and 100 mL/100 g. In specific examples, the carbonaceous aggregate selected is a carbon black having a BET surface area within the range of from about 170 m²/g, e.g., from about 200 m²/g, to about 1500 m²/g and a DBP within the range of from about 100 to about 300 mL/100 g.

Generally, the carbon black particles utilized herein are aggregates formed from primary particles. While the primary particles can have a mean primary particle size within the range of from about 10 to about 50 nanometers (nm), e.g., about 15, about 20, about 25, about 30 or about 40 nm, the aggregates can be considerably larger. Carbon black aggregates have fractal geometries and are commonly referred to as carbon black “particles” (not to be confused with the “primary particles” discussed above). Similar terminology may be applied to other carbonaceous aggregates

Some of the examples described herein employ relatively small carbon black particles (aggregates) and in many cases, the carbon black particles are less than about 300-400 nanometers (nm) in size. Illustrative mean or average carbon black particle sizes that can be utilized are within the range of from about 50 nm to about 300 nm, e.g., from 75 nm to about 250 nm, such as from about 75 nm to about 200 nm. In one example, the particle size is within the range of from about 100 to about 175 nm. In another example the particle size is within the range of from about 100 nm to about 150 nm. In a further example, the particles utilized have a mean or average particle size of about 125 nm. In one implementation, the mean particle size is 60 nm, with a spread between 30 nm and 150 nm.

Carbon blacks having suitable properties for use in the present invention may be selected and defined by the ASTM standards (see, e.g., ASTM D 1765-03 Standard Classification System for Carbon Blacks Used in Rubber Products), by Cabot Corporation specifications (see, Web site www.cabot-corp.com), or other commercial grade specifications.

Various types of carbon black can be utilized. Exemplary carbon blacks include but are not limited to ASTM N100 series—N900 series carbon blacks, for example N100 series carbon blacks, N200 series carbon blacks, N300 series carbon blacks, N700 series carbon blacks, N800 series carbon blacks, or N900 series carbon blacks.

The carbon black can be one or a combination of carbon blacks. Suitable grades of carbon black, such as from Cabot Corporation, Columbian Chemicals, Birla Carbon, or Evonik Degussa GmbH, can have surface properties such as those described above. Exemplary commercially available carbon blacks include but are not limited to carbon blacks sold under the Regal®, Black Pearls®, Spheron®, Sterling®, and Vulcan® trademarks available from Cabot Corporation, the Raven®, Statex®, Furnex®, and Neotex® trademarks and the CD and HV lines available from Columbian Chemicals, and the Corax®, Durax®, Ecorax®, and Purex® trademarks and the CK line available from Evonik (Degussa) Industries.

The carbon black can be a furnace black, channel black, lamp black, thermal black, acetylene black, plasma black, a short quench furnace carbon black, a carbon product containing silicon-containing species, and/or metal containing species and the like. For purposes of the present invention, a short quench carbon black is a carbon black formed by a process wherein the carbon black, after formation from pyrolysis, is subjected a short quench to stop the carbon black forming reactions. The short quench is a parameter of the furnace carbon black manufacturing process that assures the value of the CB Toluene Discoloration (tested per ASTM D1618) of 95%, or lower.

Examples of available short quench carbon blacks that can be utilized in the method of the invention include, but are not limited to, Vulcan® 7H carbon black, Vulcan® J carbon black, Vulcan® 10H carbon black, Vulcan® 10 carbon black, Vulcan® K carbon black, Vulcan® M carbon black, and N-121 carbon black.

In some examples, the carbon black or other carbonaceous aggregate employed contains small molecules and/or polymers, either ionic or nonionic, that are adsorbed on its surface.

In other examples, the carbon black or other carbonaceous aggregate has functional groups (e.g., derived from small molecules or polymers, either ionic or nonionic) that are directly attached to its surface. Examples of functional groups that can be directly attached (e.g., covalently) to the surface of the carbon black particles or other carbonaceous aggregates and methods for carrying out the surface modification are described, for example, in U.S. Pat. No. 5,554,739 issued to Belmont on Sep. 10, 1996 and U.S. Pat. No. 5,922,118 to Johnson et al. on Jul. 13, 1999, the teachings of both being incorporated herein by reference in their entirety. As one illustration, a surface modified carbon black that can be employed here is obtained by treating carbon black with diazonium salts formed by the reaction of either sulfanilic acid or para-amino-benzoic acid (PABA) with HCl and NaNO₂. Surface modification of carbon black by sulfanilic or para-amino-benzoic acid processes using diazonium salts, for example, results in carbon blacks that have effective amounts of hydrophilic moieties on the carbon particle surface.

Suitable carbon blacks, modified using sulfanilic acid, PABA, and so forth are commercially available in dry form from Cabot Corporation under the Emperor name; in dispersions, such modified carbon blacks may be found commercially under the Cab-O-Jet name, also from Cabot Corporation.

Other carbon blacks having functional groups attached to the surface that are suitable for use herein are described in U.S. Pat. No. 7,300,964, issued to Niedermeier, et al, on Nov. 27, 2007.

Oxidized (modified) carbon black, such as described, for example, in U.S. Pat. No. 7,922,805 issued to Kowalski, et al. on Apr. 12, 2011, and in U.S. Pat. No. 6,471,763 issued to Karl on Oct. 29, 2002, and incorporated herein by reference in their entirety, also can be utilized, as can carbon blacks with no chemical modification of the carbon black surface after formation of the carbon black particle. An oxidized carbon black is one that that has been oxidized using an oxidizing agent in order to introduce ionic and/or ionizable groups onto the surface. Oxidized carbon blacks prepared in this manner have been found to have a higher degree of oxygen-containing groups on the surface. Oxidizing agents include, but are not limited to, oxygen gas, ozone, peroxides such as hydrogen peroxide, persulfates, including sodium and potassium persulfate, hypohalites such a sodium hypochlorite, oxidizing acids such a nitric acid, and transition metal containing oxidants, such as permanganate salts, osmium tetroxide, chromium oxides, or ceric ammonium nitrate. Mixtures of oxidants may also be used, particularly mixtures of gaseous oxidants such as oxygen and ozone. Other surface modification methods, such as chlorination and sulfonylation, may also be employed to introduce ionic or ionizable groups.

Examples of commercially available chemically oxidized carbon blacks (modified using a chemical treatment to increase the amount of oxygen at the surface) include but are not limited to: Mogul carbon blacks from Cabot Corporation; Black Pearls E, Black Pearls L, Black Pearls 1000, Black Pearls 1300, Black Pearls 1400, and Black Pearls 1500 carbon blacks from Cabot Corporation, Monarch 1300, Monarch 1000, Monarch 1400, and Monarch 1500 carbon blacks from Cabot Corporation, Regal 400 and Regal 400R carbon blacks (Cabot Corporation); Mitsubishi 2700, 2400, 2650, and 2350 carbon blacks and carbon blacks identified as MA Raven 5000, Raven 7000, Raven 3500, Raven 1255, Raven 1100, Raven 1080, Raven 1060, Raven 1040, Raven 1035 and Raven 14 carbon blacks from Columbian Chemical Company, and FW200, FW2, FW2V, Special Black 4, Special Black 4A, Special Black 5, Special Black 6, Printex 150 T, Special Black 550, Special Black 350, Special Black 250, and Special Black 100 carbon blacks from Orion Engineered Carbons, formerly Evonik Industries.

Suitable modified carbon blacks and other carbonaceous aggregates may have surface areas such as described above, e.g., within the range of from about 10 m²/g to 1500 m²/g BET area, for example from about 200 m²/g to about 1500 m²/g.

The term “carbonaceous aggregates” also refers to a carbonaceous aggregate comprising a carbon phase and a silicon-containing species phase. A description of such an aggregate as well as approaches for making this aggregate are described in PCT Publication No. WO 96/37547 and WO 98/47971 as well as U.S. Pat. Nos. 5,830,930; 5,869,550; 5,877,238; 5,919,841; 5,948,835; and 5,977,213. All of these patents and publications are hereby incorporated herein by reference in their entireties. The term carbonaceous aggregates also refers to a carbonaceous aggregate comprising a carbon phase and other metal-containing species phase where the metal-containing species phase can be a metal such as magnesium, calcium, titanium, vanadium, cobalt, nickel, zirconium, tin, antimony, chromium, neodymium, lead, tellurium, barium, cesium, iron, molybdenum, aluminum, and zinc, and mixtures thereof. Such aggregates are described in U.S. Pat. No. 6,017,980, also incorporated herein by reference in its entirety. In addition, the term “carbonaceous aggregates” refers to a silica-coated carbon black, such as that described in U.S. Pat. No. 5,916,934, also hereby incorporated in its entirety herein by reference.

In the context of oil-water emulsions, one important factor to consider is the degree of hydrophobicity of the carbonaceous aggregate. Generally, hydrophilic materials have high affinity for water; they are usually self-dispersible in aqueous solution; hydrophobic materials on the other hand have low affinity for or “dislike” water and preferentially disperse in an “oil” phase. In many embodiments, the carbonaceous aggregates employed for emulsion stabilization are particles that have some of each functionality (hydrophilic or hydrophobic) so that they are thermodynamically or kinetically stable at the oil-water interface.

The contact angle of the particle (e.g., the carbonaceous aggregates described above) to the surface of the droplet is a characteristic of its hydrophobicity. If the contact angle of the particle to the interface is low, the particle will be more likely to partition to one of the phases than to the oil-water interfaces and may not prevent coalescence of the droplets. Particles that are partially hydrophobic (i.e. contact angle of approximately 90°) are better stabilizers because they are partially wettable by both liquids in the emulsion and therefore bind better to the surface of the droplets. Good or adequate stabilization also can be obtained with contact angles that are, for example, between 60 to 120°, such as, for instance, 70 to 110°, e.g., between 75 to 105° or between 80 to 100°. Surface modified or oxidized carbon blacks are examples of particulate materials in which a given particle can have both a partial hydrophobic and a partial hydrophilic character.

In certain embodiments, the overall hydrophobic/hydrophilic character of the carbonaceous aggregate is controlled by using blends of hydrophobic carbonaceous aggregates and hydrophilic carbonaceous aggregates. With carbon blacks, for example, a portion of the particles used can be hydrophobic, unmodified carbon black materials, in minor amounts, i.e., less than 50% by total weight of the particles, with the balance provided by modified, hydrophilic carbon black particles. In some implementations, the amount of hydrophobic, unmodified carbon black used is within the range of from about 0.5%, for instance from about 1%, to less than 50%, e.g., to less than about 45%, 40%, 35%, 30%, 25%, 20% or 15% by total weight of the particles. In other implementations, the amount of hydrophobic, unmodified carbon black used within the range of from about 5% or from about 10% to less than about 50%, e.g., to about 45% or 40% by total weight of the particles.

Taking into consideration the particular solvent employed, the carbonaceous aggregates can be selected to provide good colloidal stability. For instance, for aqueous solvents forming the continuous phase in an oil-water emulsion, good colloidal stability can be achieved using some surface modified carbon blacks, e.g., p-amino benzoic acid treated or sulfanilic acid treated carbon black. Other factors that may play a role in how an emulsion will be stabilized are the shape and/or size of the carbonaceous aggregates.

The carbonaceous aggregates, e.g., carbon black, can be provided in various forms, including powders. Slurries, dispersions, suspensions or other systems in which carbonaceous aggregates are provided in a fluid, e.g., liquid, carrier also can be employed. In many cases, the carbonaceous aggregates, the fluid carrier and, optionally, other ingredients form a multi-, e.g., a two-phase system. In specific embodiments, the carbonaceous aggregate is a carbon black and in particular a surface modified carbon black, provided as a dispersion in a suitable medium, often water or an aqueous carrier.

Dispersions may include surfactants and/or dispersants added, e.g., to enhance the colloidal stability of the composition. Anionic, cationic and nonionic dispersing agents can be employed.

Representative examples of anionic dispersants or surfactants include, but are not limited to, higher fatty acid salts, higher alkyldicarboxylates, sulfuric acid ester salts of higher alcohols, higher alkyl-sulfonates, alkylbenzenesulfonates, alkylnaphthalene sulfonates, naphthalene sulfonates (Na, K, Li, Ca, etc.), formalin polycondensates, condensates between higher fatty acids and amino acids, dialkylsulfosuccinic acid ester salts, alkylsulfosuccinates, naphthenates, alkylether carboxylates, acylated peptides, α-olefin sulfonates, N-acrylmethyl taurine, alkylether sulfonates, secondary higher alcohol ethoxysulfates, polyoxyethylene alkylphenylether sulfates, monoglycylsulfates, alkylether phosphates and alkyl phosphates, alkyl phosphonates and bisphosphonates, including hydroxylated or aminated derivatives. For example, polymers and copolymers of styrene sulfonate salts, unsubstituted and substituted naphthalene sulfonate salts (e.g. alkyl or alkoxy substituted naphthalene derivatives), aldehyde derivatives (such as unsubstituted alkyl aldehyde derivatives including formaldehyde, acetaldehyde, propylaldehyde, and the like), maleic acid salts, and mixtures thereof may be used as the anionic dispersing aids. Salts include, for example, Na⁺, Li⁺, K⁺, Cs⁺, Rb⁺, and substituted and unsubstituted ammonium cations. Specific examples include, but are not limited to, commercial products such as Versa®4, Versa®7, and Versa®77 (National Starch and Chemical Co.); Lomar®D (Diamond Shamrock Chemicals Co.); Daxad®19 and Daxad®K (W. R. Grace Co.); and Tamol®SN (Rohm & Haas). Another suitable anionic surfactant is Aerosol®OT (sodium dioctyl sulfosuccinate), available from Cytec Industries Inc.

Representative examples of cationic surfactants include aliphatic amines, quaternary ammonium salts, sulfonium salts, phosphonium salts and the like.

Representative examples of nonionic dispersants or surfactants include fluorine derivatives, silicone derivatives, acrylic acid copolymers, polyoxyethylene alkyl ether, polyoxyethylene alkylphenyl ether, polyoxyethylene secondary alcohol ether, polyoxyethylene styrol ether, ethoxylated acetylenic diols (such as Surfynol®420, Surfynol®440, and Surfynol®465, available from Air Products), polyoxyethylene lanolin derivatives, ethylene oxide derivatives of alkylphenol formalin condensates, polyoxyethylene polyoxypropylene block polymers, fatty acid esters of polyoxyethylene polyoxypropylene alkylether polyoxyethylene compounds, ethylene glycol fatty acid esters of polyethylene oxide condensation type, fatty acid monoglycerides, fatty acid esters of polyglycerol, fatty acid esters of propylene glycol, cane sugar fatty acid esters, fatty acid alkanol amides, polyoxyethylene fatty acid amides and polyoxyethylene alkylamine oxides. For example, ethoxylated monoalkyl or dialkyl phenols may be used, such as Igepal® CA and CO series materials (Rhone-Poulenc Co.), Brij® Series materials (ICI Americas, Inc.), and Triton® series materials (Dow Company). These nonionic surfactants or dispersants can be used alone or in combination with the aforementioned anionic and cationic dispersants.

The dispersing agents may also be a natural polymer or a synthetic polymer dispersant. Specific examples of natural polymer dispersants include proteins such as glue, gelatin, casein and albumin; natural rubbers such as gum arabic and tragacanth gum; glucosides such as saponin; alginic acid, and alginic acid derivatives such as propyleneglycol alginate, triethanolamine alginate, and ammonium alginate; and cellulose derivatives such as methyl cellulose, carboxymethyl cellulose, hydroxyethyl cellulose and ethylhydroxy cellulose. Specific examples of polymeric dispersants, including synthetic polymeric dispersants, include polyvinyl alcohols, such as Elvanol polymers from E. I. du Pont de Nemours and Company (“DuPont”), polyvinylpyrrolidones such as Luvitec and Kollidon polymers from BASF, Plasdone homopolymers and co-polymers from Ashland Specialty products, polyvinypirrolidine or poly(meth)acrylic formulations such as poly(meth)acrylic acid, Ethacryl dispersants from Arkema. Examples also include Alcosperse polymers from AkzoNobel N. V., acrylic acid-(meth)acrylonitrile copolymers, potassium (meth)acrylate-(meth)acrylonitrile copolymers, vinyl acetate-(meth)acrylate ester copolymers and (meth)acrylic acid-(meth)acrylate ester copolymers; styrene-acrylic or methacrylic resins such as styrene-(meth)acrylic acid copolymers, such as Carbopol polymers from Lubrizol Corporation, styrene-(meth)acrylic acid-(meth)acrylate ester copolymers, such as the Joncryl polymers from BASF, styrene-α-methylstyrene-(meth)acrylic acid copolymers, styrene-.alpha.-methylstyrene-(meth)acrylic acid-(meth)acrylate ester copolymers; styrene-maleic acid copolymers; styrene-maleic anhydride copolymers, vinyl naphthalene-acrylic or methacrylic acid copolymers; vinyl naphthalene-maleic acid copolymers; and vinyl acetate copolymers such as vinyl acetate-ethylene copolymer, vinyl acetate-fatty acid vinyl ethylene copolymers, vinyl acetate-maleate ester copolymers, vinyl acetate-crotonic acid copolymer and vinyl acetate-acrylic acid copolymer; and salts thereof. Polymers, such as those listed above, variations and related materials, that can be used for dispersants are included in the Tego dispersants from Evonik Industries, the EFKA additives from Ciba Specialty Chemicals, and the Disperbyk and Byk dispersants from BYK Chemie.

Dispersions that can be used to supply carbonaceous particles or aggregates to form particle-stabilized emulsions can be characterized by parameters such as: amount of solids present, viscosity, pH, particle size, appearance and so forth. Suitable amounts of carbonaceous aggregates that can be employed can depend on the specific application and can be easily determined by a person skilled in the art. For instance, illustrative dispersions can contain carbon black in an amount within the range of from about 5% to about 30%, for example, from about 10% to about 25%, such as from about 15% to about 20% or 25% by weight. In one implementation, the dispersion has 15 weight % of carbon black. In other implementations, a water suspension includes 8, 10, 12, or 14% of carbon black by weight.

The pH of the dispersion may be adjusted, for example, to a pH between 7.5 and 9.5, for instance between 7.8 and 9, e.g., between 7.8 and 8.5, and in some cases between 8.0 and 8.5, by dialyzing the dispersion containing carbonaceous aggregates, e.g., carbon black. This technique both removes impurities from the dispersion and can also adjust the pH of the dispersion by adjusting the degree of ionization of the surface ionizable groups (e.g., COOH versus COO⁻Na⁺). The degree of surface treatment and of ionization of the carbon black may be adjusted to control the pH of the dispersion and the general hydrophilic/lipophilic balance of the carbon black.

One illustrative example uses a dispersion of para-amino-benzoic acid treated high surface area carbon black. Another illustrative example uses a dispersion of sulfanilic acid treated high surface area carbon black. Both can be produced by the diazonium process described, for example, in U.S. Pat. No. 5,922,118. Other suitable CB dispersions include the dispersions described in U.S. Pat. No. 6,503,311 issued to Karl, et al., on Jan. 7, 2003 and U.S. Pat. No. 6,451,100 issued to Karl, et al, on Sep. 17, 2002. These patents are incorporated herein by reference in their entirety. Many carbon black dispersions that can be utilized herein are commercially available, for example from Cabot Corporation, Boston, Mass. and other suppliers. If desired, dispersions also can be prepared by techniques known in the art.

In one embodiment, the starting carbonaceous aggregate is provided via a dispersion containing surface modified carbon black particles that have an overall hydrophilic character, obtained, for instance, by surface modification with diazonium salts of sulfanilic or para-amino-benzoic acid. Lowering the pH below 7, e.g., 6.5 or below, such as to about: 6.0, 5.5, 5.0, 4.5, 4.0, 3.5, 3.0, 2.5, or 2.0, for instance to within the range of from about of from about 5 to about 1.5, such as within the range of from about 4 and about 2 or from about 3 and about 2, such as to a pH of about 2, is believed to result in protonation of the acidic sites on the carbon black surface, promoting coagulation of some of the particles, thus increasing the viscosity of the dispersion, and also reducing the hydrophilicity of the modified carbon black.

The particles employed for emulsion stabilization can include one or more than one type of carbonaceous aggregate as well as combinations of carbonaceous and non-carbonaceous materials. In one example, the stabilizing particles include more than one type of carbon black particles. Carbonaceous particles or aggregates also can be provided in combination with “other” or “secondary” particles, for instance other types of carbon-based particles (e.g., amorphous carbon, such as, expanded graphite, fullerenes, carbon nanotubes, e.g., single and multi (including double) walled nanotubes, activated carbon and other types of carbon-based particles) or with at least one material such as an inorganic compound that does not contain carbon, e.g., silicon or other metal oxide particles or combinations thereof.

In some implementations, selected carbon blacks, for example carbon blacks having an effective amount of surface hydrophilic modification, are combined, e.g., blended, with other, secondary, particles such as, for example, colloidal silica, precipitated silica, unmodified fumed silica, typically made by a pyrogenic process, hydrophobically modified fumed, colloidal, or precipitated silica, clays, e.g., bentonite, aluminas, titania, zirconia, ceria, palladium, activated carbon, tin oxide, magnesium aluminum silicate, magnesium oxide, any combination thereof, or other suitable particulate materials. Particle mixtures can be selected to vary the balance of the wettability properties of unmodified carbon black's hydrophobic particle surface and the emulsifying properties of modified carbon black and/or other particles.

Amounts utilized can vary. In many cases, the “other” or “secondary” particle(s) is/are present in the blend in minor amounts, i.e., less than 50%, e.g., within the range of from about 1% to about 49%, for instance, from about 5% to about 45%, or from about 10% to about 40%, for example from about 15% to about 35%, such as from about 20% to about 30% by total weight of particles. In other cases, it is the carbonaceous aggregate, e.g., surface modified carbon black, that is present in a minor amount, e.g., within the range of from about 1% to about 49%, for instance, from about 5% to about 45%, or from about 10% to about 40%, for example from about 15% to about 35%, such as from about 20% to about 30% by total weight of particles.

When silica is utilized, unmodified fumed silica particles (i.e., made via pyrogenic process) can be useful to stabilize emulsions e.g., for a short term. In many cases, hydrophobic modified silica particles are preferred for longer term emulsion stability. Specific examples utilize partially treated silica particles which are interfacially active (i.e. they will spontaneously arrange themselves at the water-oil interface and thus stabilize the emulsion).

Untreated silica particles (which typically are hydrophilic) can be treated with an agent that associates with or covalently attaches to the silica surface, e.g., to add some hydrophobic characteristics. Silica treating agents can be any suitable silica treating agent and can be covalently bonded to the surface of the silica particles or can be present as a non covalently bonded coating. Typically, the silica treating agent is bonded either covalently or non covalently to silica.

In many cases, the silica treating agent can be a silicone fluid, for example a non functionalized silicone fluid or a functionalized silicone fluid, hydrophobizing silanes, functionalized silanes, silazanes or other silica treating agents, e.g., as known in the art.

Examples of alkoxysilanes and silazanes suitable for treating fumed or colloidal silicas are described in U.S. Patent Application Publication No. 2008/0070146 to Fomitchev et al., published on Mar. 20, 2008, incorporated herein by reference in its entirety. U.S. Pat. No. 7,811,540, issued Oct. 12, 2010 to Adams and incorporated herein by reference in its entirety, describes silyl amines that can be utilized in treating fumed or colloidal silicas. In certain embodiments, the silica-treating agent comprises a charge modifying agent such as one or more of those disclosed in U.S. Patent Application Publication 2010/0009280 to Liu et al., published on Jan. 14, 2010, the contents of which are incorporated herein by reference. Alternatively or in addition, the dimethylsiloxane co-polymers disclosed in U.S. patent application Ser. No. 12/798,540, filed Apr. 6, 2010, the content of which is incorporated herein by reference, may be used to treat silica particles. At least partial treatment of particulate silica also can be obtained by using polydimethylsiloxane (PDMS) and the like, as described, for instance, in U.S. Pat. No. 6,503,676, issued to Yamashita, et al. on Jan. 3, 2003, which is incorporated herein by reference in its entirety.

Aspects of the invention also can be carried out using amorphous carbon, such as, expanded graphite, fullerenes, carbon nanotubes, e.g., single and multi (including double) walled nanotubes, activated carbon and other types of carbon-based particles, as well as combinations thereof.

The particle stabilized emulsions described herein also employ a binder consisting of, consisting essentially of or comprising a compound that can be subsequently carbonized, as further described below. In many implementations the binder is soluble in water. Binders with partial solubility in water, as well as binders that are oil-based also can be utilized. In some cases, the binder is an organic compound having a high carbon content, for example, at least about 100 carbon atoms.

In specific examples the binder is or includes a polymeric material such as, for example, a phenolic resin, for instance phenol formaldehyde Novolac or phenol formaldehyde resole resin, one or more polysaccharides (including di-saccharides), dyes and other carbon-rich organic materials. Other suitable binder materials include synthetic or natural resins such as alkyds, acrylics, vinyl-acrylics, vinyl acetate/ethylene (VAE), polyurethanes, polyesters, melamine resins, epoxy, gilsonite and others, natural organic binders such as gelatin, casein, gum ghatti, cellulose gum, dextrin, molasses, sucrose, corn starch and others, as well as any combinations thereof.

The binder can be selected by considering the specific emulsion components, the techniques contemplated for carbonizing the binder, processing conditions, desired properties of the porous carbon material to be produced, such as, for instance, mechanical strength and/or porosity, or other criteria.

In addition to a liquid medium (e.g., oil-water), carbonaceous aggregates, optional secondary particles, and binder, the particle stabilized emulsions described herein may include one or more surfactants, e.g., to optimize emulsion characteristics. Surfactant(s) such as described above can be provided in a dispersion containing the carbonaceous aggregates, and/or in combination with secondary particles or with the binder. In further implementations, the surfactant is added independently at a suitable point in the emulsion preparation process.

Shaking, stirring (manually or by machine) and/or other suitable mixing techniques can be employed to form the particle-stabilized emulsions described herein. Blenders or mixers that can be used include but are not limited to cement mixers, hand-held impellers, ribbon blenders and others. Mixers having double ribbon blades, planetary mixers and so forth also can be utilized. Parameters such as mixing speed, temperature, degree of shear, order and/or rate of addition of the ingredients and many others can be adjusted by routine experimentation and may depend on the scale of the operation, the physical and/or chemical nature of the ingredients, and so forth. In some cases, effective mixing can be determined by the consistency of the blend. Mixing can be terminated when the blend has become so viscous as to stick to the walls of the mixing vessel, with the blades of the mixer no longer engaging the material.

To form oil-water emulsions stabilized by carbonaceous aggregates and optional secondary particles, the ingredients can be combined and mixed in any suitable order. For instance, carbon black particles can be added to an oil-water emulsion also containing the binder, with subsequent blending. In another approach, a water-based dispersion containing carbon black particles, e.g., surface-modified, is first mixed with the binder. Oil is then added and the resulting combination mixed. Other step sequences can be developed without undue experimentation.

Suitable emulsions typically will form and remain stable at least until the solvent can be removed from the emulsion, as further described below.

Emulsion stabilization can be assessed in terms of the contact angle discussed above. “Stable” emulsions typically have a contact angle between 60° and 120°, such as, for instance, 70 to 110°, e.g., between 75 to 105° or between 80 to 100°. In one example, the emulsion is characterized by a contact angle of 90°.

Degrees of emulsion stabilization also can be assessed, for example, by the time required for the emulsion, once formed, to become unstable, e.g., by coalescence or by another destabilization mechanism. If a rapid step sequence is employed (e.g., with the drying step immediately following preparation of the emulsion), even less than ideal stabilization can be useful. Longer term stabilization allows added process flexibility and in many examples the emulsion will remain stable for at least 24 hours, typically, for at least 3 days, a week, 2 weeks, 3 weeks, a month and longer, e.g., three or six months. In one example, once the emulsion is formed, there is no observable change in droplet size for at least three days or over the processing time period (i.e., from the time of forming the emulsion until the solvent begins to be removed). In another example, the droplet size increases by no more than 10% for at least three days or until the solvent is removed.

The pH of the emulsion can be controlled and, in specific embodiments, the pH is lowered, e.g., by adding an acid, for instance a mineral acid such as HCl. Other approaches for controlling the pH can be used, as known in the art.

In one example, a dispersion including surface modified carbon black particles, obtained, for instance, with sulfanilic or para-amino-benzoic acid using diazonium salts is combined with the binder in a mixing apparatus. The pH is lowered below 7, e.g., to about pH below 7, e.g., 6.5 or below, such as to about: 6.0, 5.5, 5.0, 4.5, 4.0, 3.5, 3.0, 2.5, or 2.0, for instance to within the range of from about 5 to about 1.5, such as within the range of from about 4 and about 2 or from about 3 and about 2, thus increasing the viscosity of the dispersion, and also reducing the hydrophilicity of the modified carbon black particle (increasing the hydrophobic character of its surface). Oil, e.g., a hydrocarbon such as octane, is then added and the ingredients are blended together to obtain an emulsion of uniform consistency, with no apparent separation of the oil phase.

Generally, ingredients can be provided in any suitable amounts and ratios and these amounts can depend on factors such as desired properties, processing parameters, specific nature of the components selected and many others. Amounts and ratios to be used in specific situations can be determined by routine experimentation and/or calculations.

In a particle stabilized emulsion, saturation typically occurs when the surface of the immiscible droplet (e.g., the oil droplet in an O/W emulsion) is completely covered with solid particles.

Many Pickering emulsions are formed by using the minimum amount of particles necessary to stabilize the emulsion. Using low particle loadings can minimize possible contamination or burden introduced into a system by the stabilizing particles, lessening recovery or purification requirements. As used herein, the term “low particle loading” refers to emulsions that utilize less that the saturation amounts, where the saturation amount is the amount of stabilizing particles needed to generate one monolayer around the droplet. In some cases, just a few particles around a droplet having a surface mostly uncovered by stabilizing particles may be sufficient to produce a stabilized emulsion. For instance, emulsions having low particle loadings contain carbon black in an amount of less than 5% by weight of the water phase of the emulsion.

In contrast, many of the embodiments described herein utilize high particle loadings. As used herein, the term “high particle loading” refers to using amounts of solid particles that exceed the amount required to stabilize the emulsion. Considering, for example, an oil-water emulsion stabilized by carbon black particles, the carbon black particles that stabilize the emulsion are found at the droplet-solvent interface and are referred to herein as “interfacial” particles. At high particle loadings, the concentration of carbon black in the emulsion is such that the continuous phase of the emulsion (regardless of whether this continuous phase is the oil or the aqueous phase) will also contain carbon black particles. The carbon black particles present in the continuous phase are believed to promote or enhance formation of the networks or frameworks characterizing the monoliths further described below.

In specific examples, the concentration of carbon black in the emulsion is at least about 5% by weight of the continuous, e.g., water or aqueous, phase of the emulsion, for example within the range of from about 5% to about 7% from about 7% to about 10%; from about 10% to about 12% from about 12% to about 15%; from about 15% to about 17% from about 17% to about 20%; from about 20% to about 22% from about 22% to about 25%; from about 25% to about 27%; from about 27% to about 30%; from about 30% to about 32%; from about 32% to about 35%; from about 35% to about 37%; from about 37% to about 40%; from about 40% to about 42%; from about 42% to about 45%; from about 45% to about 47%; from about 47% to about 50%; from about 50% to about 52%; or from about 52% to about 55%. Higher amounts also can be employed.

Similar high loadings can be provided to form emulsions containing other carbonaceous aggregates or combinations of carbonaceous aggregates and non-carbonaceous, e.g., silica, solid particles. Excess carbonaceous aggregates will typically migrate to the phase in which they are preferentially wetted.

The amount of binder, e.g., a suitable resin, can be within the range of from about, 5 wt % to about 40 wt % for instance, within the range of from about 5 to about 35, such as from 10 to about 30, e.g., from 15 to about 25, from 10 to about 20, based on total weight of a dispersion containing carbon black or another suitable carbonaceous aggregate. Levels of binder added can be determined by considering factors such as surface area of the carbonaceous particles or aggregates, desired mechanical properties of monolith or other criteria. Typically, for a given binder, higher binder amounts promote mechanical strength, possibly reducing the surface area of the porous carbon monolith. Lower binder amounts tend to favor increased surface areas, while possibly decreasing mechanical strength. Binder amounts used can be selected to achieve a desired tradeoff between mechanical strength and surface area. In many cases, the binder is provided at relatively low levels, in amounts sufficient to generate bridges and connections needed to form the monolith.

In carbon black stabilized emulsions, ratios by weight of organic resin binder to carbon black can be, for example, within the range of from about 0.01, e.g., from about 0.05, 0.1 or 0.2 to about 2, for instance within the range of from about 0.5 to about 0.8; from about 0.8 to about 1.0; from about 1.0 to about 1.2; from about 1.2 to about 1.4; from about 1.4 to about 1.6; from about 1.6 to about 1.8; from about 1.8 to about 2 wt/wt. In a specific example, the ratio of organic resin to carbon black is about 0.1, 0.2, 0.3, 0.4, or 0.5 wt/wt. In other examples, the ratio used is within the range of from about 0.3 wt/wt to about 0.6 wt/wt of binder to carbon black particles. Similar levels can be used with other carbonaceous aggregates. Increasing the amount of binder tends to increase fracture toughness but can also generate more ash.

Oil can be present in an amount within the range of from as little as desired, e.g., 0.01 percent (%) to about 50% by volume, for instance from about 1% to about 40%, e.g., from about 5% to about 35%, or from about 10% to about 30%, such as from about 15% to about 25%. The suitable amount of oil to be included can be determined by considering factors such as desired porosity of the monolith, processing conditions, viscosity of the oil used or other criteria. For example, the porosity of the porous carbon monoliths described herein can be controlled by adjusting the solvent ratio (oil phase to aqueous phase).

If utilized, the amount of surfactant added may depend on the surface area of particles, as well as the nature of the surfactant; sufficient surface coverage may be necessary to provide the right particle wettability (i.e. contact angle between about 60 to about 120 degrees to be interfacially active).

After blending, typical viscosities (which determines how easily the suspension flows) can be within the range of from about 20 Pascal·second (Pa·s) to about 1200 Pa·s, e.g., within the range of from about 100 Pa·s to about 900 Pa·s, such as, from about 200 Pa·s to about 500 Pa·s.

Typical elastic modulus (which determines the rigidity of the suspension) can be between about 200 and 10⁵ Pa, for instance, between 1000 Pa and 10⁴ Pa. Both viscosity and modulus may be measured in a rheometer.

In some implementations, the emulsion is thick, e.g., paste or gel-like, having a smooth appearance and keeping its shape when scooped with a spatula. It is believed that retaining some elasticity of the continuous phase can prevent collapse caused by capillary stresses that may occur during liquid removal.

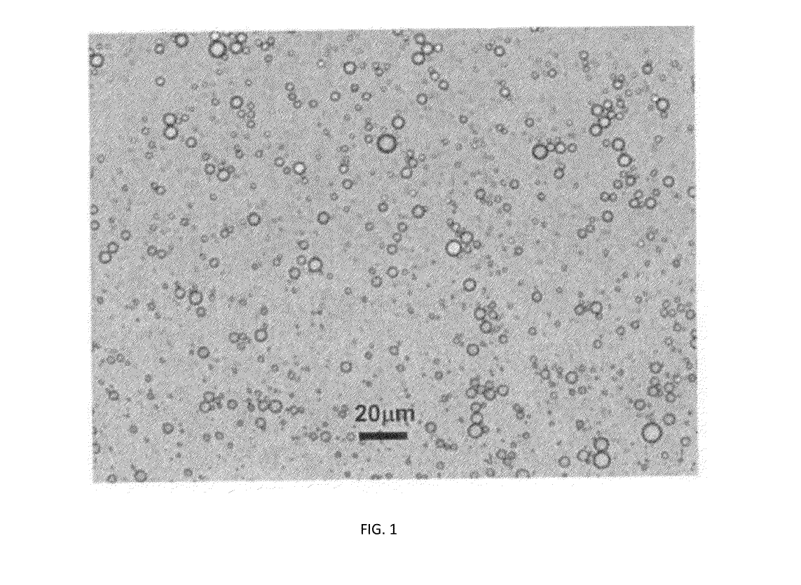

The particle stabilized emulsions can be observed using known analytical techniques. For instance, an optical micrograph image of typical carbon black stabilized Pickering emulsion is presented as FIG. 1. Whether the emulsion is an O/W rather than W/O emulsion can be determined by adding a water-soluble dye and determining whether the dye is visible in the continuous phase. Other suitable techniques also can be employed.

Before further processing, liquids (e.g., solvents and/or droplet materials) present in the wet particle stabilized emulsion (e.g., the paste-like material described above) can be removed, for example by drying or calcining the wet product. Liquids can be removed, for example, by drying at room temperature, in ambient air. Ovens, furnaces and/or special atmospheres also can be employed, as can be placing the wet product in circulating gas, e.g., a flowing air stream. In general, the drying temperature selected is below the decomposition temperature of the organic material employed. In many cases, drying is conducted at a temperature below about 200° C., e.g., below about 160° C., below about 120° C. or below about 90° C. In one example, the temperature used is within the range of from about 30° C. to about 40° C.

Suitable liquid removal times can be determined by routine experimentation, taking into consideration the size of the sample, the drying temperature employed and so forth. In many implementations, solvent removal is conducted in such a manner, e.g., slowly and/or gently enough, to avoid or minimize pore collapse. In one example, solvent volatilization leaves behind pores (also referred to herein as “voids” or “cavities” that have a size that is the same or substantially the same as the droplet size present in the Pickering emulsion before drying.

The particle stabilized emulsion product, preferably dried, e.g., as described above, is subjected to a treatment by which the binder is decomposed to form carbon. The transformation is also referred to herein as “carbonization”, and the binder can be described as being “carbonized”.

In one embodiment, the binder is decomposed by being heated to a sufficiently high temperature, typically in the absence of oxygen (O₂). In the case of polymeric binders, the process can be thought of as a pyrolysis in an inert atmosphere and can include loss of side chains, hydrogen release, extensive breakdown of the carbon structure and the evolution of tar and volatile organic compounds, resulting in the formation of elemental carbon. In specific examples, the process transforms a resin binder, e.g., a phonolic resin binder, to a carbon residue capable of forming connections, or “bridges”, that hold together or “glue” to one another particles previously present in the continuous phase of the emulsion.

The specific temperature required to decompose (carbonize) the binder will typically depend on the nature of the binder being employed. In many cases, the temperature is above about 600° C., for example, above about 700° C., 800° C., 900° C., 1000° C. or higher, such as, for example, 1100° C., 1200° C., 1300° C. or 1400° C. In specific situations, the suitable temperature is within the range of from about 600° C. to about 1500° C., e.g., between 800° C. and 1400° C., between 900° C. and 1300° C., between 900° C. and 1200° C. or between 900° C. and 1100° C. In other cases the temperature is between 600° C. and 900° C., between 700° C. and 1000° C., between 1000° C. and 1200° C., between 1000° C. and 1200° C. or between 1200° C. and 1400° C. Vacuum or an inert atmosphere such as nitrogen, argon, another inert gas or a combination of inert gases can be used to prevent exposure to atmospheric oxygen. The time required to decompose (carbonize) the binder will typically depend on the size of the sample, nature of the resin, and so forth, and can be determined by routine experimentation. In many cases, the resin can be decomposed (carbonized) within a few hours or less.

In one example, an air dried, particle stabilized emulsion product, containing a phenolic resin as the binder is carbonized by being heated to a temperature of about 1000° C. in nitrogen for a period of two hours.

Heating that results in the decomposition of the binder is expected to affect the carbonaceous aggregate, e.g., carbon black, minimally (e.g., some minor graphitization may take place) or not at all. If secondary particles are being used, they typically will retain their chemical composition and physical properties under the heating conditions employed to decompose the binder.

In some implementations, a single heating operation can be used to accomplish both the solvent removal and the decomposition step. In these cases, the wet particle stabilized emulsion is first exposed to a heat treatment step effective to remove the solvent, preferably in a manner that prevents or minimizes collapse of the pore structure, followed by heating and maintaining the dry product at the binder decomposition temperature. Thus a wet particle stabilized emulsion can be subjected to one or more stages involving ramping up the temperature to a desired intermediate or final temperature, followed by a heat-treatment, or annealing step during which the sample is maintained at a constant or substantially constant temperature. In many cases, the first heating stage, to the solvent removal temperature, can be carried out slowly or in steps, while subsequent heating of the dry sample to the decomposition temperature may be slow or more rapid, and can be conducted step-wise or by a continuous ramping of the temperature. Ramping and/or heat-treatment time intervals can be determined experimentally.

Binder decomposition also can be accomplished using other techniques. For instance, the binder can be decomposed by chemical means. In one example, a particle stabilized emulsion such as described above and preferably dried, is treated with a suitable agent, e.g., concentrated sulfuric acid, capable of removing hydrogen and oxygen (dehydration) resulting in a carbon residue similar to the carbon residue discussed above.

A combination of approaches, e.g., heat and chemical means, also can be used.

The resulting material is referred to herein as a porous carbon “monolith”. It can be thought of as a nanostructured material having a carbon scaffolding supporting an interconnected network of pores. The carbon scaffolding may be in the form of carbon black or other carbonaceous aggregates used in the templating emulsion. Typically, the porous carbon phase of the monolith will also contain carbon generated through the decomposition of the binder. Also, in some cases, heating and in particular heating at temperatures of 1000° C. and higher can graphitize some of the carbonaceous aggregates utilized as starting materials. Thus if carbon black is employed in the templating emulsion, the resulting porous carbon monolith may contain not only carbon black but also graphitized carbon black.

The presence of graphitized carbon black can be determined by Raman spectroscopy or another suitable technique. Using Raman spectroscopic techniques revealed that, in some porous carbon monoliths, obtained by heating above 1000° C., the in plane correlation length, Lₐ, is higher (e.g., by a few Angstroms) than the Lₐ of the precursor carbon black used to stabilized the templating emulsion. In one example, the value of Lₐ or the starting carbon black material was 17-18 A, while the Lₐ determined for the resulting porous carbon monolith was 21.3 A. The higher Lₐ values are thought to be indicative of increased ordering such as obtained by aligning graphitic layers.

In many embodiments, the carbon present in the porous carbon monolith is at least 95% amorphous.

In addition to the carbon phase (e.g., in the form of carbon black, possibly graphitized carbon black and carbonized binder) and porosity, the porous carbon monolith could also contain optional secondary materials such as colloidal silica, precipitated silica, unmodified fumed silica, typically made by a pyrogenic process, hydrophobically modified fumed, colloidal, or precipitated silica, clays, e.g., bentonite, aluminas, titania, zirconia, ceria, palladium, activated carbon, tin oxide, magnesium aluminum silicate, magnesium oxide, combination thereof, or other suitable materials used in preparing the particle stabilized emulsion and not decomposed during the process steps described above.

Typically, the porous carbon monolith has a density that is lower than the density of the starting carbonaceous aggregate. For example, the density of carbon black is about 1.86 g/cm³; a porous carbon monolith templated by a carbon black stabilized emulsion has a density that is lower than about 1.86 g/cm³. In many implementations, the porous carbon monolith has a density that is lower than about 1.0 g/cm³, 0.8 g/cm³, 0.6 g/cm³, 0.4 g/cm³, 0.2 g/cm³ or lower than 0.10 g/cm³, e.g., 0.09 g/cm³. In specific examples, the density of the porous carbon monolith is within the range of from about 0.10 g/cm³ to about 1.20 g/cm³, from about 0.20 g/cm³ to about 0.80 g/cm³, from about 0.30 g/cm³ to about 0.70 g/cm³, from about 0.40 g/cm³ to about 0.6 g/cm³, from about 0.10 g/cm³ to about 0.3 g/cm³, from about 0.3 g/cm³ to about 0.5 g/cm³, from about 0.5 g/cm³ to about 0.7 g/cm³, from about 0.7 g/cm³ to about 0.9 g/cm³, from about 0.9 g/cm³ to about 1.1 g/cm³. In one example, the density is from about 0.25 g/cm³ to about 0.3 g/cm³. Lower densities can be obtained if more pores are created by increased incorporation of the internal phase; higher densities can be obtained if less internal phase is incorporated.

The porous carbon monolith described herein has a bimodal pore distribution, containing macropores determined or controlled by the emulsion droplet size and mesopores controlled by the size and packing of the carbonaceous aggregates. In many embodiments, especially those employing carbon black, the macropores are at least about 0.5 μm in diameter, typically within the range of from about 1.0 μm to about 200 μm, e.g., from about 5 to about 150 or from about 20 to about 100 μm. Mesopores can be within the range of from a few nm, e.g., 10 nm, to about 100 nm. In specific examples, the mesopores are from about 20 nm to about 90 nm, e.g., from about 30 nm to about 80 nm, from about 40 nm to about 70 nm or from about 50 nm to about 60 nm.

In many aspects of the invention, these pore size distributions do not overlap or do not substantially overlap. In one implementation, fewer than 10% of the pores have a diameter from about 110 nm to about 490 nm, for example, fewer than about 8% of the pores, fewer than about 6%, fewer than about 4%, or fewer than about 2% of the pores have a diameter from about 110 nm to about 490 nm.

Typically, the porous carbon monolith have a total amount of porosity of at least about 5, about 10, about 15, about 20, about 25, about 30%, about 35; about 40, about 45, about 50, about 55 or higher by volume %). In many cases, the total porosity is within the range of from about 5 to about 10; from about 10 to about 15; from about 15 to about 20; from about 20 to about 25; from about 25 to about 30; from about 30 to about 35; from about 35 to about 40; from about 40 to about 40; from about 40 to about 45; from about 45 to about 50; from about 50 to about 55 volume %. For instance, the total porosity can be about 30 to about 45 or from about 35 to about 50 volume %. Higher or lower levels of total porosity also can be obtained.

In specific embodiments, the ratio of the number of pores having a size within the first range (from about 0.5 μm to about 100 μm) to the number of pores having a size within the second range (about 1 nm to about 100 nm) is from about 90:10 to about 10:90, for example, about 90:10 to about 80:20, about 80:20 to about 70:30, about 70:30 to about 60:40, about 60:40 to about 50:50, about 50:50 to about 40:60, about 40:60 to about 30:70, about 30:70 to about 20:80, or about 20:80 to about 10:90.

Levels of porosity caused by particle (aggregate) packing (the mesoporosity discussed above) can be varied by varying the surface area and structure (DBP) of the carbonaceous aggregate, e.g., carbon black, employed in the templating emulsion.

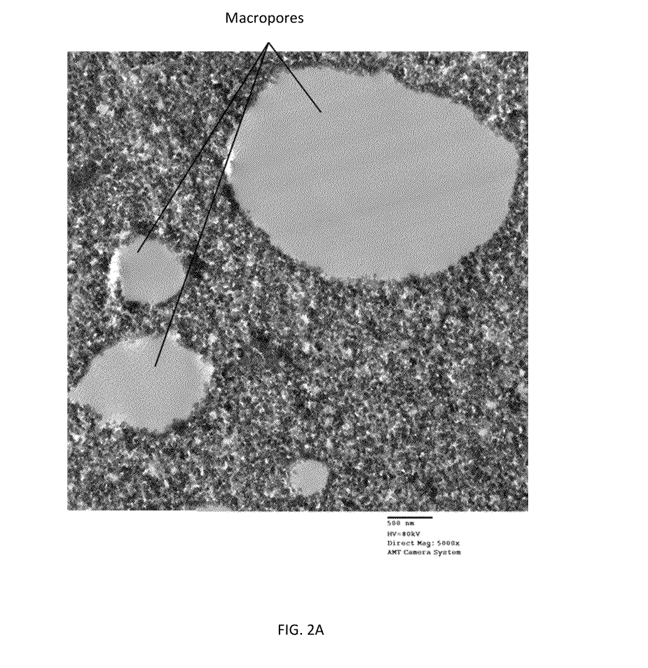

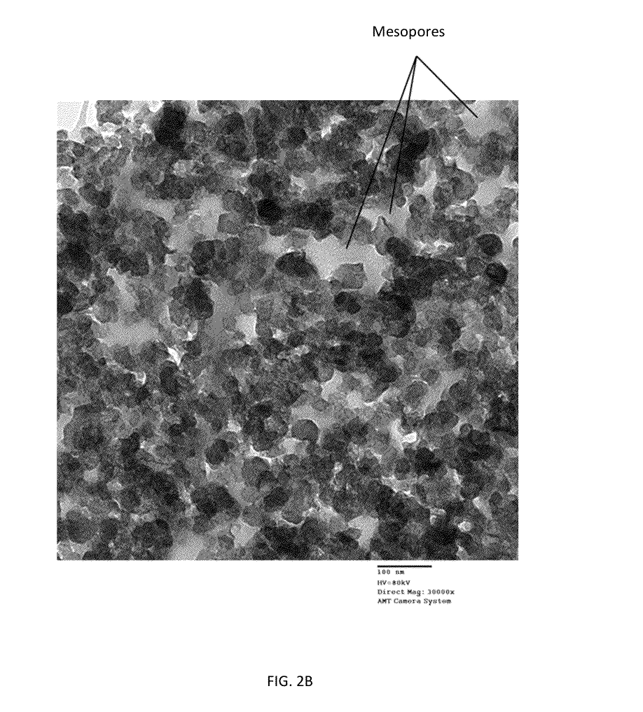

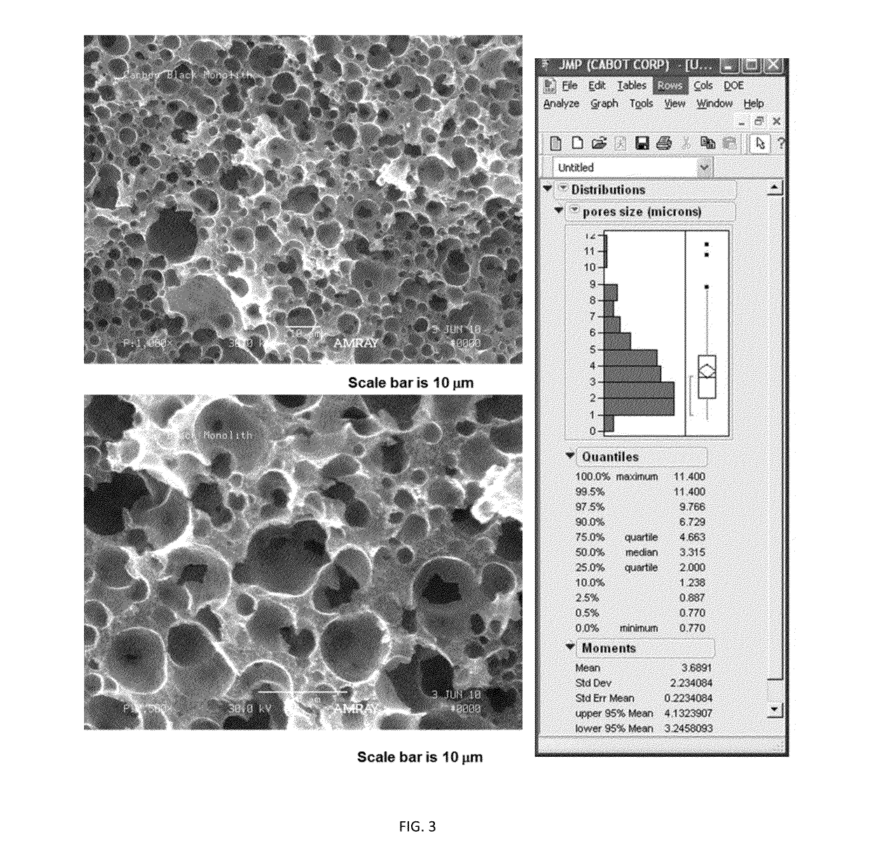

The porous carbon monoliths can be observed using known analytical techniques such as transmission electron microscopy (TEM), scanning electron microscopy (SEM), He ion microscopy, X-ray tomography, or other suitable techniques. For instance, typical macropores and mesopores of porous carbon monoliths can be seen, respectively, in the thin section TEM images of FIGS. 2A and 2B. FIG. 3 is a SEM image showing macropores (1-12 microns) template by emulsion drops.

Images obtained are highly suggestive of interconnected pores and in some of the porous carbon monoliths at least a portion of the porosity present is interconnected porosity.

Quantitative assessments of macroporosity and/or mesoporosity present in a porous carbon monolith sample can be determined by nitrogen gas adsorption and/or by mercury porosimetry.

In many aspects of the invention, the porous carbon monoliths described herein are not friable (do not crumble between the fingers) under typical handling and can withstand further processing such as being inserted or pressed into a frame, attached to a support or other operations. In one example, a monolith prepared using a 15 weight % carbon loading has a compression modulus of about 5 MPA (measured using an Instron mechanical tester according to ASTM test standard C-165-05). As discussed above, improved mechanical properties may be obtained by increasing the amount of carbon (e.g., selecting a resin having a high carbon content and/or increasing loading levels of the carbonaceous aggregates) used in the templating emulsion.

The porous carbon monolith can be further processed. For example, it can used to generate particulate materials. Grinding, surface modifications and/or other operations can be utilized.

In specific examples, a molded porous carbon monolith is comminuted using a technique such as grinding to obtain granules having, for example, a mean particle size within the range of from about 9 to about 100 microns, for instance, from about 20 to about 80, or from about 30 to about 60 microns. Porous carbon monoliths in particulate form can have spherical, elongated or irregular shapes. SEM data obtained before and after particle reduction indicated that the porous structure of the monolith was preserved.

Smaller particles, e.g., fine powders, of porous carbon monolith can be agglomerated, using techniques known in the art to form larger particles.

The monolith described herein can be surface treated. In one example, at least one organic group is attached to the surface of the porous carbon monolith. If the size of the monolith is reduced, e.g., by granulation, the organic group(s) is/are attached before or after size reduction is carried out.

Techniques for attaching an organic group to carbonaceous materials and examples of organic groups are described in U.S. Pat. Nos. 5,554,739; 5,559,169; 5,571,311; 5,575,845; 5,630,868; 5,672,198; 5,698,016; 5,837,045; 5,922,118; 5,968,243; 6,042,643; 5,900,029; 5,955,232; 5,895,522; 5,885,335; 5,851,280; 5,803,959; 5,713,988; and 5,707,432; and International Patent Publication Nos. WO 97/47691; WO 99/23174; WO 99/31175; WO 99/51690; WO 99/63007; and WO 00/22051; all incorporated in their entirety by reference herein. Generally, these techniques permit the attachment of an organic group to the carbonaceous material via a chemical reaction.

In one embodiment, the process for attaching an organic group to the carbonaceous materials involves the reaction of at least one diazonium salt with a carbonaceous material in the absence of an externally applied current sufficient to reduce the diazonium salt. That is, the reaction between the diazonium salt and the carbonaceous material proceeds without an external source of electrons sufficient to reduce the diazonium salt. Mixtures of different diazonium salts may be used. This process can be carried out under a variety of reaction conditions and in any type of reaction medium, including protic and aprotic solvent systems or slurries.

The diazonium salt employed can be derived from a primary amine having one of the desired groups and being capable of forming, even transiently, a diazonium salt. The organic group may be an aliphatic group, a cyclic organic group, or an organic compound having an aliphatic portion and a cyclic portion. The organic group may be substituted or unsubstituted, branched or unbranched. Aliphatic groups include, for example, groups derived from alkanes, alkenes, alcohols, ethers, aldehydes, ketones, carboxylic acids, and carbohydrates. Cyclic organic groups include, but are not limited to, alicyclic hydrocarbon groups (for example, cycloalkyls, cycloalkenyls), heterocyclic hydrocarbon groups (for example, pyrrolidinyl, pyrrolinyl, piperidinyl, morpholinyl, and the like), aryl groups (for example, phenyl, naphthyl, anthracenyl, and the like), and heteroaryl groups (imidazolyl, pyrazolyl, pyridinyl, thienyl, thiazolyl, furyl, indolyl, and the like). As the steric hindrance of a substituted organic group increases, the number of organic groups attached to the carbonaceous material from the reaction between the diazonium salt and the carbonaceous material may be diminished.

When the organic group is substituted, it may contain any functional group compatible with the formation of a diazonium salt. Functional groups include, but are not limited to, R, OR, COR, COOR, OCOR, carboxylate salts such as COOLi, COONa, COOK, COONR₄, halogen, CN, NR₂, SO₃H, sulfonate salts such as SO₃Li, SO₃Na, SO₃K, SO₃⁻NR₄⁺, OSO₃H, OSO₃⁻ salts, NR(COR), CONR₂, NO₂, PO₃H², phosphonate salts such as PO₃HNa and PO₃Na₂, phosphate salts such as OPO₃HNa and OPO₃Na₂, N═NR, NR₃⁺X⁻, PR₃⁺X⁻, SₖR, SSO₃H, SSO₃⁻ salts, SO₂NRR′, SO₂SR, SNRR′, SNQ, SO₂NQ, CO₂NQ, S-(1,4-piperazinediyl)-SR, 2-(1,3-dithianyl) 2-(1,3-dithiolanyl), SOR, and SO₂R. R and R′, which can be the same or different, are independently hydrogen, branched or unbranched C1-C20 substituted or unsubstituted, saturated or unsaturated hydrocarbon, e.g., alkyl, alkenyl, alkynyl, substituted or unsubstituted aryl, substituted or unsubstituted heteroaryl, substituted or unsubstituted alkylaryl, or substituted or unsubstituted arylalkyl. The integer k ranges from 1-8 and preferably from 2-4. The anion X⁻is a halide or an anion derived from a mineral or organic acid. Q is (CH₂)_{w}, (CH₂)xO(CH₂)_{z}, (CH₂)ₓNR(CH₂)_{z}, or (CH₂)S(CH₂)_{z}, where w is an integer from 2 to 6 and x and z are integers from 1 to 6. In the above formula, specific examples of R and R′ are NH₂—C₆H₄—, CH₂CH₂—C₆H₄—NH₂, CH₂—C₆H4-NH₂, and C₆H₅.

Another example of an organic group is an aromatic group of the formula A_{y}Ar—, which corresponds to a primary amine of the formula A_{y}ArNH₂. In this formula, the variables have the following meanings Ar is an aromatic radical such as an aryl or heteroaryl group. Ar can be selected from the group consisting of phenyl, naphthyl, anthracenyl, phenanthrenyl, biphenyl, pyridinyl, benzothiadiazolyl, and benzothiazolyl; A is a substituent on the aromatic radical independently selected from a preferred functional group described above or A is a linear, branched or cyclic hydrocarbon radical (preferably containing 1 to 20 carbon atoms), unsubstituted or substituted with one or more of those functional groups; and y is an integer from 1 to the total number of —CH radicals in the aromatic radical. For instance, y is an integer from 1 to 5 when Ar is phenyl, 1 to 7 when Ar is naphthyl, 1 to 9 when Ar is anthracenyl, phenanthrenyl, or biphenyl, or 1 to 4 when Ar is pyridinyl.

Another set of organic groups which may be attached to the porous carbon monolith are organic groups substituted with an ionic or an ionizable group as a functional group. An ionizable group is one which is capable of forming an ionic group in the medium of use. The ionic group may be an anionic group or a cationic group and the ionizable group may form an anion or a cation.

Ionizable functional groups forming anions include, for example, acidic groups or salts of acidic groups. The organic groups, therefore, include groups derived from organic acids. Preferably, when it contains an ionizable group forming an anion, such an organic group has a) an aromatic group or a C₁-C₁₂ alkyl group and b) at least one acidic group having a pKa of less than 11, or at least one salt of an acidic group having a pKa of less than 11, or a mixture of at least one acidic group having a pKa of less than 11 and at least one salt of an acidic group having a pKa of less than 11. The pKa of the acidic group refers to the pKa of the organic group as a whole, not just the acidic substituent. More preferably, the pKa is less than 10 and most preferably less than 9. Preferably, the aromatic group or the C₁-C₁₂ alkyl group of the organic group is directly attached to the carbonaceous material. The aromatic group may be further substituted or unsubstituted, for example, with alkyl groups. The organic group can be a phenyl or a naphthyl group and the acidic group is a sulfonic acid group, a sulfinic acid group, a phosphonic acid group, or a carboxylic acid group. The organic group may also contain one or more asymmetric centers. Examples of these acidic groups and their salts are discussed above. The organic group can be a substituted or unsubstituted sulfophenyl group or a salt thereof; a substituted or unsubstituted (polysulfo)phenyl group or a salt thereof, a substituted or unsubstituted sulfonaphthyl group or a salt thereof, or a substituted or unsubstituted (polysulfo)naphthyl group or a salt thereof. An example of a substituted sulfophenyl group is hydroxysulfophenyl group or a salt thereof.

Specific organic groups having an ionizable functional group forming an anion (and their corresponding primary amines for use in a process according to the invention) are p-sulfophenyl (p-sulfanilic acid), 4-hydroxy-3-sulfophenyl (2-hydroxy-5-amino-benzenesulfonic acid), and 2-sulfoethyl (2-aminoethanesulfonic acid).

Amines represent examples of ionizable functional groups that form cationic groups. For example, amines may be protonated to form ammonium groups in acidic media.

Preferably, an organic group having an amine substituent has a pKb of less than 5. Quaternary ammonium groups (—NR₃⁺) and quaternary phosphonium groups (—PR₃⁺) also represent examples of cationic groups. The organic group can contain an aromatic group such as a phenyl or a naphthyl group and a quaternary ammonium or a quaternary phosphonium group. The aromatic group is preferably directly attached to the carbonaceous material. Quaternized cyclic amines, and even quaternized aromatic amines, can also be used as the organic group. Thus, N-substituted pyridinium compounds, such as N-methyl-pyridyl, can be used in this regard. Examples of organic groups include, but are not limited to, (C₅H₄N)C₂H₅⁺X⁻, C₆H₄(NC5H₅)⁺X⁻, C₆H₄COCH₂N(CH₃)₃⁺X⁻, C₆H₄COCH₂(NC₅H₅)⁺X⁻, (C₅H₄N)CH₃⁺X⁻, and C₆H₄CH₂N(CH₃)₃⁺X⁻, where X⁻is a halide or an anion derived from a mineral or organic acid.

Aromatic sulfides encompass another group of organic groups. These aromatic sulfides can be represented by the formulas Ar(CH₂)_{q}Sₖ(CH₂)ᵣAr′ or Ar(CH₂)_{q}Sₖ(CH₂)ᵣAr″ wherein Ar and Ar′ are independently substituted or unsubstituted arylene or heteroarylene groups, Ar″ is an aryl or heteroaryl group, k is 1 to 8 and q and r are 0-4. Substituted aryl groups would include substituted alkylaryl groups. Examples of arylene groups include phenylene groups, particularly p-phenylene groups, or benzothiazolylene groups. Aryl groups include phenyl, naphthyl and benzothiazolyl. The number of sulfurs present, defined by k preferably ranges from 2 to 4. Examples of carbonaceous material products are those having an attached aromatic sulfide organic group of the formula —(C₆H₄)—Sₖ(C₆H₄)—, where k is an integer from 1 to 8, and more preferably where k ranges from 2 to 4. Other examples of aromatic sulfide groups are bis-para-(C₆H₄)—S2-(C₆H₄)— and para-(C₆H₄)—S₂—(C₆H₅). The diazonium salts of these aromatic sulfide groups may be conveniently prepared from their corresponding primary amines, H₂N—Ar—Sₖ—Ar′—NH₂ or HN—Ar—Sₖ—Ar″. Groups include dithiodi-4,1-phenylene, tetrathiodi-4,1-phenylene, phenyldithiophenylene, dithiodi-4,1-(3-chlorophenylene), -(4-C₆H₄)—S—S-(2-C₇H₄NS), -(4-C₆H₄)—S—S-(4-C₆H₄)—OH, -6-(2-C₇H₃NS)—SH, -(4-C₆H₄)—CH₂CH₂—S—S—CH₂CH₂-(4-C₆H₄)—, -(4-C₆H₄)—CH₂CH₂—S—S—S—CH₂CH₂-(4-C₆H₄)—, -(2-C₆H₄)—S—S-(2-C₆H₄)—, -(3-C₆H₄)—S—S-(3-C₆H₄)—, -6-(C₆H₃N₂S), -6-(2-C₇H₃NS)—S—NRR′ where RR′ is —CH₂CH₂OCH₂CH2-, -(4-C₆H₄)—S—S—S—S-(4-C₆H₄)—, -(4-C₆H₄)—CH═CH₂, -(4-C₆H₄)—S—SO₃H—, -(4-C₆H₄)—SO₂NH-(4-C₆H₄)—S—S-(4-C₆H₄)—NHSO₂-(4-C₆H₄)—, -6-(2-C₇H₃NS)—S—S-2-(6-C₇H₃NS)—, -(4-C₆H₄)—S—CH₂-(4-C₆H₄)—, -(4-C₆H₄)—SO₂—S-(4C₆H₄)—, -(4-C₆H₄)—CH₂—S —CH₂- (4-C₆H₄)—, -(3- C₆H₄)—CH₂—S —CH₂-(3-C₆H₄)—, -(4-C₆H₄)—CH₂—S—S—CH₂-(4-C₆H₄)—, -(3-C₆H₄)—CH₂—S—S—CH₂-(3-C₆H₄)—, -(4-C₆H₄)—S—NRR′ where RR′ is —CH₂CH₂OCH₂CH₂—, -(4-C₆H₄)—SO₂NH—CH₂CH₂—S—S—CH₂CH₂—NHSO₂-(4-C₆H₄)—, -(4-C₆H₄)-2-(1,3-dithianyl), and -(4-C₆H₄)—S-(1,4-piperizinediyl)-S-(4-C₆H₄)—.

Another set of organic groups which may be attached to the porous carbon monolith are organic groups having an aminophenyl, such as (C₆H₄)—NH₂, (C₆H₄)—CH₂—(C₆H₄)—NH₂, (C₆H₄)—SO₂—(C₆H₄)—NH₂. In specific examples, the organic group is a C₁-C₁₀₀ alkyl group (e.g., a C₁-C₁₂ alkyl group), an aromatic group, or other organic group, monomeric group, or polymeric group, each optionally having a functional group or ionic or ionizable group. In further examples, these groups are directly attached to the porous carbon monolith.

The polymeric group can be any polymeric group capable of being attached to a carbon product. The polymeric group can be a polyolefin group, a polystyrenic group, a polyacrylate group, a polyamide group, a polyester group, or mixtures thereof. Monomeric groups are monomeric versions of the polymeric groups.

The organic group can also be an olefin group, a styrenic group, an acrylate group, an amide group, an ester, or mixtures thereof. The organic group can also be an aromatic group or an alkyl group, either group with an olefin group, a styrenic group, an acrylate group, an amide group, an ester group, or mixtures thereof, wherein preferably the aromatic group, or the alkyl group, like a C₁-C₁₂ group, is directly attached to the carbon product.

The polymeric group can include an aromatic group or an alkyl group, like a C₁-C₁₂ group, either group with a polyolefin group, a polystyrenic group, a polyacrylate group, a polyamide group, an polyester group, or mixtures thereof.

The organic group can also comprise an aralkyl group or alkylaryl group, which is preferably directly attached to the carbon product. Other examples of organic groups include a C₁-C₁₀₀ alkyl group, e.g., a C₂₀-C₆₀ alkyl group.

Examples of other organic groups are organic groups having the following formulas (hyphens on one or more ends represents an attachment to a carbon product or to another group):

—Ar—CO₂(CₘH₂ₘ₊₁), where m=0 to about 20;

—Ar—(CₙH₂ₙ₊₁), where n+1 to about 50;

—Ar—CₚH₂ₚAr—, where p=1 to about 10;

—Ar—CX₃, where X is a halogen atom;

—Ar—O—CX₃, where X is a halogen atom;

—Ar—SO₃⁻;

—Ar—SO₂(C_{q}H_{2q-1}), where q=about 2 to about 10;

—Ar—S₂—Ar—NH₂;

—Ar—S₂—Ar—;

—ArSO₂H;

—Ar—((CₙH₂ₙ)COOX)ₘ, where n=0 to 20, m=1 to 3, and X═H, cations, or organic group. These groups are further activated and/or reacted with such groups as carbodiimides and further reacted with NH₂-terminated functionalization groups; SOCl₂, or PCl₃, or PCl₅ to be converted to —Ar—(CₙH₂ₙ)COCl)ₘ groups and further reacted with OH-terminated functionalization groups.

—Ar—((CₙH₂ₙ)OH)ₘ, where n=0 to 20, m=1 to 3. These groups are further activated and/or reacted with such groups as tosyl chloride and subsequently reacted with amino-terminated ligands; carbonyldiimidazole and subsequently reacted with amino-terminated ligands; carbonylchloride terminated ligands; and epoxy terminated ligands.

—Ar—((CₙH₂ₙ)NH₂)ₘ, where n=0 to 20, m=1 to 3, and its protonated form: —Ar—((CₙH₂ₙ)NH₃X)ₘ, where X is an ion; These groups are further activated and/or reacted with such groups as carbodiimide activated carboxyl-terminated ligands; carbonyldiimidazole activated hydroxy-terminated ligands; tosyl activated hydroxy-terminated ligands; vinyl terminated ligands; alkylhalide terminated ligands; or epoxy terminated ligands.

—Ar—((CₙH₂ₙ)CHNH₃⁺COO⁻)ₘ where n=0 to 20 and m=1 to 3; These groups are derivatized further by reaction through the carboxylic group by reaction with NH₂ or OH terminated groups or through the amino group by reaction with activated carboxy-terminated ligands, activated hydroxy-terminated ligands, vinyl ligands, alkylhalide terminated ligands, or epoxy terminated ligands.

—Ar—((CₙH₂)CH═CH₂)ₘ, where n=0 to 20, m=1 to 3 or —Ar—((CₙH₂ₙ)SO₂CH═CH₂)ₘ, where n=0 to 20, m=1 to 3. These groups are further activated and/or reacted with such groups as amino-terminated ligands; peroxy-acids to form epoxides and subsequently reacted with hydroxy- or amino-terminated ligands; hydrogen halides to form—Ar((CₙH₂ₙ)CH₂CH₂X)ₘ groups and subsequently reacted with amino-terminated ligands.

Other reaction schemes can be used to form various groups onto the carbonaceous material.

Illustrative mixtures of organic groups include, for instance, the following:

—Ar—SO₃⁻and —Ar(CₙH₂₊₁), where n=1 to about 50;

—Ar—S₂—Ar—NH₂ and —ArCₚH₂ₚAr—, where p=1 to about 10;

—Ar—S₂—Ar—and —ArCₚH₂ₚAr—, where p=1 to about 10; or

at least two different —Ar—CO₂(CₘH₂ₘ₊₁), where m=0 to about 20.

The various organic, monomeric, and polymeric groups described above and below which are part of the modified porous carbon monolith product can be unsubstituted or substituted and can be branched or linear.

In some implementations, the organic group attached to the porous carbon monolith is an acid or base or a salt of an acid or base, and specific examples include phenyl or naphthyl groups having substituents like sulfonic acid and carboxylic acid. Quaternary ammonium can also be used. Exemplary organic groups attached to the carbonaceous material include (C₆H₄)—SO₃⁻Na⁺, (C₆H₄)—SO₃⁻K⁺, (C₆H₄)—SO₃⁻Li⁺, and the like. Generally, an acid-type organic group attachment will be useful in adsorbing basic adsorbates while a base-type organic group attachment will be useful in adsorbing acidic adsorbates.

In some embodiments, the groups used include amino acids and derivatized amino acids (e.g., phenyl alanine and its derivatives), cyclodextrins, immobilized proteins and polyproteins, and the like. Other organic groups include, but are not limited to, C₆F₅— groups and/or trifluoromethyl-phenyl groups, and bis-trifluorophenyl groups, other aromatic groups with fluorine groups, and the like. These organic groups may be used to modify porous carbon monoliths for chromatographic or other separation applications.

In further embodiments, the organic groups which are attached onto the porous carbon monolith include —Ar—(CₙH₂ₙ₊₁)ₓ group functionalities, wherein n is an integer of from about 1 to about 30 and x is an integer of from about 1 to about 3. These groups can be employed in reverse phase chromatography. Another example of an organic group is benzene with a sulfonic group, benzoic groups, isophtalic groups, which may be useful for cationic exchanges and quaternary amine groups which are preferred for anionic exchanges.

Organic groups such as cyclodextrins which are directly attached onto the carbonaceous material or attached through an alkyl group such as CₙH₂ₙ₊₁ chain wherein n is an integer of from about 3 to about 20 and also preferred. Other groups that can be attached are optically pure amino acids and derivatized amino acids, immobilized proteins, and the like. These types of organic groups can find applications with respect to chiral chromatography.

In addition, polyethyleneglycol (PEG groups) and methoxy-terminated PEG groups as well as derivatized PEG and MPEG groups can be attached onto the carbonaceous material. These types of organic groups may be utilized in affinity and/or hydrophobic interactions chromatography for the separation, for instance, of proteins and polyproteins.

Further examples of organic groups that can be attached, either alone or as an additional group, include —Ar—C(CH₃)₃, —Ar—(CₙH₂ₙ)(CN)ₘ, wherein Ar is an aromatic group, n is 0 to 20, and m is 1 to 3; —Ar—((CₙH₂ₙ)C(O)N(H)—CₓH₂ₓ₊₁)ₘ, wherein Ar is an aromatic group, n is 0 to 20, x is 0 to 20 and m is 1 to 3; —Ar—((CₙH₂ₙ)N(H)C(O)—CₓH₂ₓ₊₁)ₘ, wherein Ar is an aromatic group, n is 0 to 20, x is 0 to 20 and m is 1 to 3; —Ar—((CₙH₂ₙ)O—C(O)—N(H)—CₓH₂ₓ₊₁)ₘ, wherein Ar is an aromatic group, n is 0 to 20, x is 0 to 20 and m is 1 to 3; —Ar—((CₙH₂ₙ)C(O)N(H)—R)ₘ, wherein Ar is an aromatic group, n is 0 to 20, x is 0 to 20 and m is 1 to 3, and R is an organic group; —Ar—((CₙH₂ₙ)N(H)C(O)—R)ₘ, wherein Ar is an aromatic group, n is 0 to 20, x is 0 to 20 and m is 1 to 3, and R is an organic group; —Ar—(CₙH₂)O—C(O)N(H)—R)ₘ, wherein Ar is an aromatic group, n is 0 to 20, x is 0 to 20 and m is 1 to 3, and R is an organic group.

A combination of different organic groups also is possible. For instance, more than one type of organic group can be attached to the same porous carbon monolith material. In other approaches, a combination of porous carbon monolith materials can be utilized, wherein some of the carbonaceous material has been modified with one organic group and another portion of the carbonaceous material is unmodified or modified with a different organic group. Varying degrees of modification are also possible, such as low weight percent or surface area modification, or a high weight percent or surface area modification. Mixtures of modified carbonaceous material with different functionalizations and/or different levels of treatment also can be employed.

Attaching more than one type of group onto the porous carbon monolith can be useful in filling any gaps on the surface of the carbonaceous material not having an attached organic group. The filling in of such gaps promotes better selectivity and/or blocks any microporosity that may exist in the monolith. For example, an optional second organic group can be attached (using the same diazonium salt or other attachment methods) after the first primary organic group is attached and the modified carbonaceous material is preferably purified as described above by removing any by-products that are produced from attaching an organic group onto the porous carbon monolith material. In many cases, the type of secondary organic groups which are subsequently attached include, but are not limited to, organic groups which are shorter in chain length or have less steric hindrance than the first organic group attached. For instance, suitable secondary organic groups include, but are not limited to, phenyl groups, alkyl phenyl groups having short alkyl chains (e.g., C₁-C₁₅), and the like. Particularly preferred groups include, phenyl, methyl-phenyl, 3,5-dimethyl-phenyl, 4-isopropyl-phenyl, and 4-tert-butyl-phenyl.

The surface of the monolith preferably is modified without damaging the structure or making the material more friable. For instance, a porous carbon monolith can be surface modified with exchangeable sodium cations attached to the surface. This is very useful from the point of view of substituting different ions to alter the chemistry of the surface.

Surface treated monoliths can be further processed, e.g., granulated or agglomerated, as described above.

Because of their unusual structure, porous carbon monoliths can have a variety of applications, including but not limited to their use as supports for chromatography or catalysis, in separation and purification devices, as anode materials for lithium batteries and so forth.

For example, a monolith may be ground into particles of a suitable size and packed into a chromatographic column, such as a liquid chromatographic column, as described in U.S. Pat. No. 6,787,029, the contents of which are incorporated herein by reference. The ground particles may be surface modified (before or after grinding) as described above and in U.S. Patent Application Publication 2002/0056686, to Kyrlidis et al., published on May 16, 2002, the contents of which are incorporated herein by reference in their entirety. Additional packing materials, such as silica or other materials that selectively adsorb a particular chemical species, may be combined with the ground monolith material.

A sample containing two or more components to be separated is passed, flowed, or otherwise forced through the packed column. Due to the independent affinities of the sample components, and the retention properties of the packing material with respect to the individual sample components, chemical separation of the components is achieved as the sample passes through the packed column. The ground particles of the monolith are also useful in gas chromatographic, high performance liquid chromatographic, solid phase extraction, and other chromatographic separation techniques.

The adsorbate can be in a liquid phase or in the gaseous or vapor phase, depending upon the needs and desires of the user. Certain adsorbates can be more efficiently adsorbed from the vapor or gaseous phases than from the liquid phase or vice versa, and the porous carbon monolith, optionally modified as described herein, can be effective in adsorption from either phase.

Adsorption properties of the optionally modified monolith described herein can be demonstrated by comparing its adsorption isotherm for a given adsorbate with that of a conventional adsorbent for the same adsorbate.

The porous carbon monolith described herein also can be utilized in battery applications. As known in the art, a typical lead battery cell includes negative plates, positive plates and an electrolyte, e.g., aqueous sulfuric acid. The positive plate includes a current collector or grid which supports a chemically active positive material. A grid with a negative active material also is provided for the negative plate. Generally, the plates are arranged parallel to one another and are separated by a material that allows free movement of charged ions. Examples of conventional battery designs are provided, for instance, in U.S. Patent Application Publication No. 2003/0165742 A1, to G. S. Mann, published on Sep. 4, 2003, International Publication No. WO 2010/098796 A1, to D. A. Wetzel et al. published on Sep. 2, 2010, U.S. Patent Application No. 2004/0002006 A1, to K. C. Kelley et al., published on Jan. 1, 2004, and U.S. Patent Application No. 2003/0106205 A1 to M Daxing, published on Jun. 12, 2003, the contents of all being incorporated herein by reference in their entirety.

In one implementation, the porous carbon monolith described herein can be used to form the frame of the battery which, in many conventional designs is made of a metal such as lead. For example, an emulsion precursor can be poured into an appropriate mold then processed as described above (e.g., carbonized) to obtain the frame. The porous carbon monolith also can be used to replace porous carbon used in traditional designs for making current collector grids.

In another implementation, the porous carbon monolith, comminuted into granules, is used in a paste, for instance a paste similar to the one spread onto the pasting textile described in WO 2010/098796, or onto another type of battery frame.

In a further implementation, the porous carbon monolith is ground into particles which are then mixed with pitch or a phenolic resin that can be placed in a mold. The mixture is then re-fired to carbonize the pitch or resin.

In yet another implementation, the porous carbon monolith, e.g., ground into particles, is used in one of the electrodes, for instance as filler in the negative electrode, replacing, for example, carbon black fillers.

In lithium ion batteries, the porous composition of the carbon monolith described herein allows for a large surface area for Li-ion absorption and also provides channels for electrolyte movement.

Embodiments of the invention are further illustrated in the following non-limiting examples.

### EXEMPLIFICATION

### Example 1

This example was carried out to study the formation of pH responsive, reversible Pickering emulsions using surface modified carbon black particles.

10 ml of water and 4 drops (approximately 0.2 grams) of a sodium salt of p-aminobenzoic acid-modified CB having a BET specific surface area of 200 m²/g (CAS Number 1106787-35-2; carbon black, (4-carboxyphenyl)-modified sodium salt) dispersed at 15 wt % in water were added to a first 15 ml glass vial. The resultant dispersion was instantly miscible and had a pH of approximately 7.5.

Heptane (3 ml) was then added to the dispersion. The heptane immediately formed an immiscible layer on the top of the dispersion. The sample was then vortex mixed. Immediately after mixing, the sample appeared homogeneous. After resting for 5 minutes, the sample separated into two layers and appeared as it had before mixing.

The same procedure was repeated to a second 15 ml glass vial. Additionally, before the addition of heptane, 1 N HCl was added to the dispersion until the pH reached was 2. In this instance, immediately after vortex mixing, the sample appeared uniform and frothy. After resting for 5 minutes, three phases formed: on the bottom of the tube appeared to be flocculated carbon black particles; above was a clear layer that appeared to be water; and the top layer was an intensely dark emulsified layer, which was stable at room temperature for at least several days.

Upon microscopic examination of the emulsified layer, it was determined that the continuous phase of this top layer is water, meaning that the emulsified droplets are heptane in water. This suggests that, even though the carbon black is protonated, the particle retains more hydrophilic character than hydrophobic and is still wetted by water better than oil. This allows positioning of the particle at the interface but with more extension into the water phase.

The same procedure performed for the second vial was repeated with a third, 15 ml glass vial. After emulsion formation by vortex mixing, 1 N KOH was added in an amount sufficient to disrupt the emulsion. After further vortex mixing and resting, the sample separated into two layers and the emulsion was no longer visible.

These results suggest that the efficacy of surface modified carbon black in forming pickering emulsions can be altered by protonation and deprotonation via altering the pH.

### Example 2

This example was carried out to study the formation of carbon monoliths templated by pickering emulsions.

22.4 g Dynachem phenalloy 7700 resin solution was added to 200 ml of a sodium salt of p-aminobenzoic acid-modified CB having a BET specific surface area of 200 m²/g (CAS Number 1106787-35-2; carbon black, (4-carboxyphenyl)-modified sodium salt) dispersed at 15 wt % in water. The resultant ratio of resin to carbon black was 40% wt/wt. The resin served as a binder. 2.2 ml of 1 N HCl was then added and the solution was mixed in a Waring blender, Model 31B219. This treatment increases the viscosity of the carbon black dispersion. Addition of HCl protonates acidic sites on the surface of the carbon black, thus reducing the hydrophobicity of this surface and leading to coagulation of some of the particles. 100 ml of octane was then added to the dispersion in 10 ml increments, with 30 seconds of blending at medium speed following each addition. The emulsion appeared uniform in consistency, with no apparent phase separation of the oil phase.

The resultant emulsion was diluted in water to allow for imaging. An optical micrograph image of the emulsion is shown in FIG. 1. Water-soluble dye was added to the emulsion. The dye was visible in the continuous phase, identifying the emulsion as an oil-in water emulsion.

5.5 ml of 1 N HCl was added to the emulsion to increase its viscosity. The emulsion turned into a thick paste or gel that was smooth in appearance and kept its shape when scooped with a spatula. The sample was air-dried for several days and then heat treated under nitrogen at 1000° C. for 2 hours. This caused the resin to become carbonized and bind the carbon black particles, resulting in the formation of the monoliths.

Thin section TEM images of the monoliths formed are shown in FIGS. 2A and 2B. The carbon monoliths have controllable porosity at two length scales—macroporosity (1 μm to 100 μm), determined by the emulsion drops size and mesoporosity (a few nm to 100 nm), controlled by the size and packing of the fractal carbon black particles. Examples of macropores as well as mesopores are shown.

An SEM image of the monolith formed is shown in FIG. 3. The templating effect created by the emulsion droplets is clearly visible.

### Example 3

This example was carried out to determine the compression modulus of porous carbon monoliths according to the invention.

Samples were prepared as follows. 22.4 g Dynachem phenalloy 7700 resin solution was added to 200 ml of a sodium salt of p-aminobenzoic acid-modified CB having a BET specific surface area of 200 m2/g (CAS Number 1106787-35-2; carbon black, (4-carboxyphenyl)-modified sodium salt) dispersed at 15 wt % in water. The resultant ratio of resin to carbon black was 40% wt/wt. 2.2 ml of 1 N HCl was then added and the solution was mixed in a Waring blender, Model 31B219. 100 ml of octane was then added to the dispersion in 10 ml increments, with 30 seconds of blending at medium speed following each addition.

The emulsion was transferred into aluminum dish for air drying. After water and oil evaporated the monolith was heat treated in a furnace at 1000° C. for 2 hours under nitrogen gas.

The compressive properties of the porous carbon monolith samples were measured using Instron mechanical tester Model #5500R. Testing was done according to ASTM test standard C-165-05. Generally, a sample about 5 cm in diameter was placed on the platform of the Instron mechanical tester. The anvil attached was lowered until just touching the top of the sample. The anvil was then lowered at a rate of 0.25 mm/s and the test was run until sample failure.

The software recorded the corresponding force in Newtons and the compression in mm. The compression modulus was calculated from the value of force at failure, and precise knowledge of sample area.

Using this procedure, the compression modulus of a sample (prepared using 15 weight % carbon black and a ratio of phenolic resin to carbon black of 40% wt/wt) was 5 MPa.

### Example 4

Experiments were carried out to demonstrate applicability of various types of binders.

In one experiment the binder was starch. 224 grams (g) of a sodium salt of p-aminobenzoic acid-modified CB having a BET specific surface area of 200 m2/g (CAS Number 1106787-35-2; carbon black, (4-carboxyphenyl)-modified sodium salt) dispersed at 15 wt % in water was blended using a Waring blender, Model 31B219 on setting 2 for 45 seconds with 6.72 g corn starch (Agros Brand). This was followed by adding 2.63 g 1 N HCl, blending in the same manner. A volume of 100 mL octane was then added in 3 aliquots, blending in the same manner after each addition. Pitcher was given a few minutes to cool between additions.

This was followed by adding 3.00 g 1 N HCl according to following scheme, blending on 2 for 45 seconds after each addition:

| | Approximate Mass 1N HCl | Watt Meter Reading at End of |
|---|---|---|
| Addition | Added | Blend Time |
| 1 | 1 g | 565 |
| 2 | 1 g (2 g total) | 567 |
| 3 | 0.5 g (2.5 g total) | 515 |
| 4 | 0.5 g (3 g total) | 515 |

At this point, it was suspected that the emulsion was not being blended effectively due to its heavy grease-like consistency. It was spread in a large Petri dish to dry.

In another experiment, the binder was sucrose. 224 g of a sodium salt of p-aminobenzoic acid-modified CB having a BET specific surface area of 200 m2/g (CAS Number 1106787-35-2; carbon black, (4-carboxyphenyl)-modified sodium salt) dispersed at 15 wt % in water were shaken in a 250 mL plastic bottle with 10.64 g sucrose to dissolve the sucrose before being poured into the blending pitcher. 2.63 g HCl (1 N) were added and blended for 45 seconds on setting 2 of Waring blender, Model 31B219, before being left to sit for 10 minutes (allowing for protonation).

100 mL octane were then blended in, split between three aliquots (blending for 45 seconds on setting 2, allowing the pitcher to cool between aliquots). 3.00 g 1 N HCl were then added in increasing portions:

| | Approximate Mass 1N HCl |
|---|---|
| Addition | Added |
| 1 | 1.5 g |
| 2 | 1 g (2.5 g total) |
| 3 | 0.5 g (3 g total) |

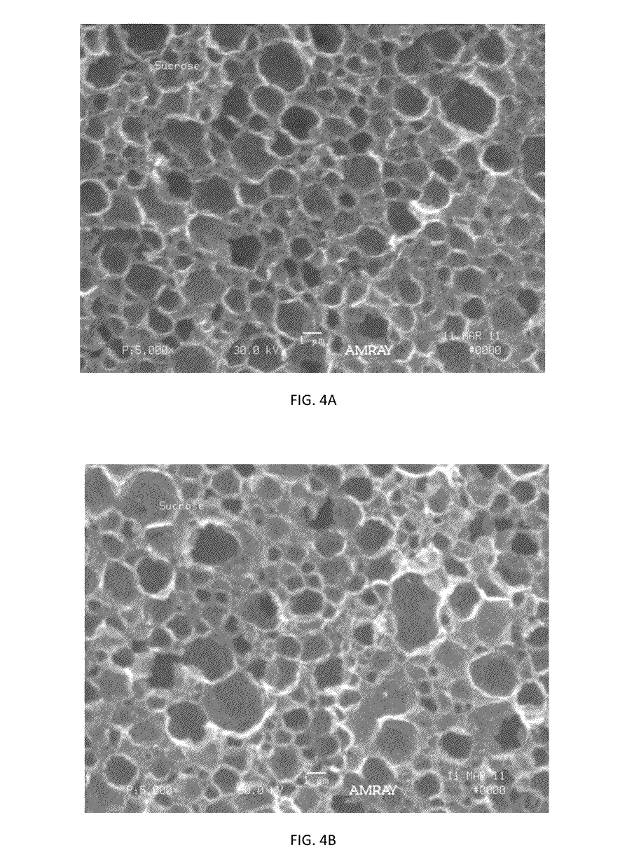

The resulting material was gel-like. It was spread onto a large Petri dish so the solvents could evaporate. Thermal treatment was conducted under nitrogen gas at a temperature of 1200° C. for two hours to produce a porous carbon monolith. SEM images of the resulting porous carbon monolith are shown as FIGS. 4A and 4B.

### Example 5

This experiment used 0.8 mmol PABA-treated carbon black and a phenolic resin binder. The specific materials were: 224.05 g carbon black having a DBP of 185-203 and a BET of 1410 dispersed in water (15 wt %); 22.38 g Dynachem 2810 phenolic resin; 100 ml octane; and 1N HCl in two additions: 19.94 g (1^{st} addition) and 15.99 g (2^{nd} addition).

The carbon black dispersion and phenolic resin were added to the pitcher with the 1st addition of HCl and blended for 45 seconds. Octane was added in three increments and mixed. After each addition the pitcher was allowed to cool down for a few minutes. The remaining HCl was added in 5 increments, blending after each addition. After the last addition the viscosity of the emulsion increased dramatically and the composition appeared as a thick gel.

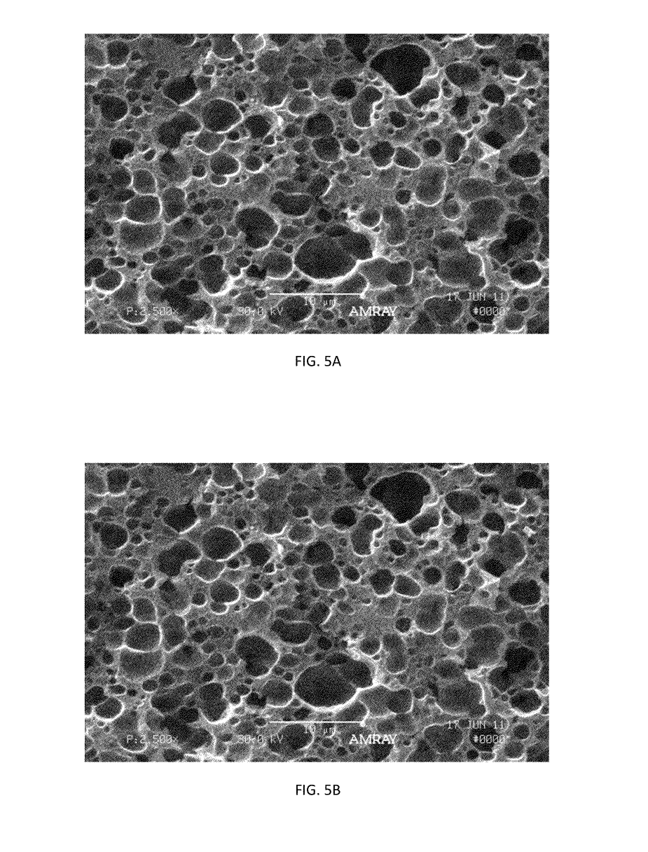

Heat treatment at 1200° C. for two hours resulted in a porous carbon monolith having the structure shown in the SEM images of FIGS. 5A and 5B.

### Example 6

A series of experiments was undertaken to measure the pore volume of porous carbon monoliths. Porous carbon monolith samples A, B and C (prepared essentially as described in Example 2 above) used carbon black (I) with DBP of 118 and BET of 240 m²/g, at 5, 15 and 30% loading, respectively. Porous carbon monolith sample D (prepared essentially as described in Example 5 above) was based on carbon black (II) having a DBP of 160 and a BET surface area of 1420 m²/g at 15% loading; in porous carbon monolith sample E (prepared, essentially as described in Example 5 above), the starting carbon black (III) had an DBP of 330 and a BET of 1420 m²/g at 15% loading. The three carbon blacks used in preparing samples A-E are described in the table below:

| Base particle | DBP | BET |
|---|---|---|
| (I) | 118 | 240 |
| (II) | 160 | 1420 |
| (III) | 330 | 1420 |

The mesoporosity (derived from the packing or carbon black particles (aggregates) within the porous carbon monoliths samples) was determined from gas adsorption measurements using nitrogen gas. The values obtained are shown in the Table below.

| Sample | Pore Volume (cm³/g) |
|---|---|
| A | 0.53 |
| B | 0.4 |
| C | 0.28 |
| D | 0.76 |
| E | 0.96 |

The results indicated that the volume of mesopores increased with increased surface area and/or structure of the carbon black used to template the monolith. Increased carbon black loading resulted in a reduction in mesopore volume.

### Example 7

Experiments were conducted to investigate effects of particle size reduction in porous carbon monoliths, prepared according to aspects of the invention, on porous structure. Generally, monoliths were prepared as described in the examples above and were ground in two batches.

In one experiment, a monolith (prepared essentially as described in Example 5 above) used carbon black (III) (DBP=330 and BET=1420 m²/g), and Dynachem 2810 phenolic resin binder. Two batches having a mean diameter, d₅₀, of 17 microns and 9.1 microns, respectively were obtained by grinding using a Waring Blender, Model 31B219 apparatus. The blender was operated in a “pulse” mode, with each pulse lasting for 30 seconds. A 4-minute grind (8 pulses) and a 6-minute grind (12 pulses) were used to produce, respectively, the first and second batch. SEM data showed that the pore structure was preserved for both batches.

In another experiment, the templating emulsion, employing carbon black (II) of Example 6 above (DBP=160 and BET=of 1420 m²/g), and Dynachem 2810 phenolic resin The emulsion was dried, then heated to 1200° C. for two hours. The resulting porous carbon monolith had a BET surface area of 367 m²/g. Two batches were prepared by grinding the batches, in pulse mode, for 6.5 minutes and 5 minutes to produce particles having a d₅₀ of 91.3 microns and 67.3 microns, respectively. SEM analysis indicated that the pore structure was preserved after grinding.

In a further experiment, the amount of resin was reduced by 50% but otherwise the templating emulsion was prepared as described above, using a carbon black having a BET surface area of 1420 m²/g and Dynachem 2810 resin. After drying and heating to 1200° C. for two hours, the BET surface area of the porous carbon monolith was 386.5 m²/g. The porous carbon monolith was ground in pulse mode using a Waring Blender, Model 31B219 apparatus and a 4 minute-grind to produce particles having a d₅₀ of 22.8 microns. SEM analysis indicated that the pore structure was preserved after grinding.

### Example 8

A solution of p-NH₃C₆H₄N₂Cl₂ is prepared by adding a cold solution of 0.028 g NaNO₂ in 3 g of water to a solution of 0.16 ml concentrated HCl, 0.043 g p-phenylenediamine and 5 g of water that was stirring in an ice bath. A 2 g block of the monolith of Example 2 is immersed in 18 g water that is stirred at room temperature. The cold diazonium solution is added to the 18 g water and allowed to react with the monolith. After stirring for one hour, the product is dried in an oven at 125° C. The monolith then has attached aminophenyl groups.

### Example 9

A sample of the monolith of Example 2 is ground for 4 minutes in a Waring Blender, Model 31B219 using a pulse mode as described in Example 7 above. The ground material is dried under nitrogen at 165° C. for two hours. A 10 g sample is placed in a 0.1M solution of nitrobenzenediazonium tetrafluoroborate in anhydrous benzonitrile for five minutes. The monolith sample is removed, rinsed twice with anhydrous benzonitrile, subjected to Soxhlet extraction overnight with THF and dried in an oven. The monolith then has attached nitrophenyl groups.

### Example 10

A sample of the monolith of Example 2 is ground for 4 minutes in a Waring Blender, Model 31B219 using a pulse mode as described in Example 7 above. A solution of 4-chlorobenzenediazonium nitrate is prepared by adding a solution of 0.014 g NaNO₂ in 3 g of water to a stirring solution of 0.025 g 4-chloroaniline, 0.070 g 90% nitric acid and 3 g of water. After stirring for 10 minutes, the diazonium solution is added to 50 g of water in which a 10 g sample of the ground monolith material is dispersed with stirring. After stirring for 30 minutes, the monolith is removed from the solution, dried in an oven at 110° C., subjected to Soxhlet extraction overnight with THF, and dried. The monolith then has attached chlorophenyl groups.

### Example 11

A sample of the monolith of Example 2 is ground for 4 minutes in a Waring Blender, Model 31B219 using a pulse mode as described in Example 7 above. A fifty gram sample of the ground material is dispersed in a solution of 8.83 g of sulfanilic acid dissolved in 420 g of water. The resulting mixture is cooled to room temperature. Nitrogen dioxide (5.16 g) is then dissolved in 30 g of ice cold water and added to the mixture over a period of several minutes and stirred rapidly to produce 4-sulfobenzenediazonium salt in situ, which reacts with the monolith. The monolith is then dried in an oven at 125° C. The resulting monolith has attached p-C₆H₄SO₃— groups.

While this invention has been particularly shown and described with references to preferred embodiments thereof, it will be understood by those skilled in the art that various changes in form and details may be made therein without departing from the scope of the invention encompassed by the appended claims.

1. A method for producing a porous carbon monolith, the method comprising:
a) forming a particle stabilized emulsion including immiscible liquids, carbonaceous aggregates and a binder;
b) removing liquids present in the particle stabilized emulsion; and
c) decomposing the binder to produce the porous carbon monolith.

2. The method of claim 1, wherein the binder is selected from the group consisting of phenolic resin, starch and sucrose.

3. The method of claim 1, wherein the binder is an organic compound having a high carbon content.

4. The method of any of claim 1, wherein the binder is decomposed by heating in the absence of oxygen.

5. The method of claim 1, wherein the binder is decomposed by heating at a temperature within the range of from about 800° C. to about 1500° C.

6. The method of claim 1, wherein the binder is decomposed by treatment with a chemical agent that removes oxygen and hydrogen from the binder molecule.

7. (canceled)

8. The method of claim 1, wherein at least a portion of the carbonaceous aggregates is present in a continuous phase of the particle stabilized emulsion.

9. The method of claim 1, wherein the porous carbon monolith is further processed to obtain a particulate material.

10. The method of claim 1, further comprising attaching at least one organic group to a surface of the porous carbon monolith.

11. (canceled)

12. The method of claim 1, wherein the carbonaceous aggregates comprise carbon black.

13. The method of claim 12, wherein the carbon black particles are provided in an amount within the range of from about 5 to about 55 weight percent based on an aqueous phase of the emulsion.

14. The method of claim 12, wherein the ratio by weight of binder to carbon black is within the range of from about 0.2 to about 2.

15. The method of claim 12, wherein the immiscible liquids include water and an organic compound immiscible with water and the ratio of carbon black to the organic compound is within the range of from about 0.16 to about 0.96 by weight.

16. The method of claim 1, wherein the carbonaceous aggregate is at least partially hydrophilic.

17-20. (canceled)

21. The method of claim 1, wherein the carbonaceous aggregate comprises a surface-modified carbon black or an oxidized carbon black.

22. (canceled)

23. The method of claim 1, wherein the particle-stabilized emulsion further contains particles selected from the group consisting of unmodified fumed silica, colloidal silica, hydrophobically modified fumed silica, hydrophobically modified colloidal silica, hydrophobically modified precipitated silica, clay, alumina, activated carbon, ceria, palladium, unmodified carbon black particles and any combination thereof.

24. The method of claim 1, wherein the carbonaceous aggregate is provided as carbon black particles in an aqueous dispersion.

25. The method of claim 24, wherein the dispersion is a dispersion of sulfanilic acid treated high surface area carbon black or a dispersion of para-amino-benzoic acid treated high surface area carbon black.

26-29. (canceled)

30. A porous carbon monolith comprising carbon and porosity, wherein the carbon includes carbonaceous aggregates and carbonized binder and said porosity comprises first pores having a pore size within the range of from about 0.5 μm to about 100 μm and second pores having a pore size within the range of from about 1 nm to about 100 nm, wherein a pore size distribution of the first pores does not substantially overlap with a pore size distribution of the second pores.

31-37. (canceled)

38. The porous carbon monolith of claim 30, wherein the carbonaceous aggregates comprise carbon black and optional graphitized carbon black.

39. The porous carbon monolith of claim 38, wherein the porous carbon monolith has a density within the range of from about 0.25 to about 0.3 g/cm³.

40. (canceled)

41. The porous carbon monolith of claim 30, wherein said monolith has at least one organic group attached to its surface.

42. A chromatographic medium including the porous carbon monolith of claim 30.

43. A battery device including the porous carbon monolith of claim 30.

44. A particle stabilized oil-water emulsion comprising a binder and carbon black particles in an amount of at least 5% by weight of the water phase of the emulsion, wherein partial hydrophobicity and partial hydrophilicity are displayed in the same carbon black particle.
